(19) United States
(12) Patent Application Publication
(10) Pub. No.: US 2016/0122502 A1
(43) Pub. Date: May 5, 2016

(54) COMPONENT PARTS PRODUCED BY THERMOPLASTIC PROCESSING OF POLYMER/BORON NITRIDE COMPOUNDS, POLYMER/BORON NITRIDE COMPOUNDS FOR PRODUCING SUCH COMPONENT PARTS AND USE THEREOF

(71) Applicant: 3M INNOVATIVE PROPERTIES COMPANY, St. Paul, MN (US)

(72) Inventors: Krishna Uibel, Waltenhofen (DE); Armin Kayser, Groenenbach (DE); Johanna Zimmermann, Luebeck (DE)

(21) Appl. No.: 14/895,102

(22) PCT Filed: Jun. 18, 2014
(86) PCT No.: PCT/EP2014/062800

§ 371 Date: Dec. 1, 2015

(30) Foreign Application Priority Data
Jun. 19, 2013 (EP) 13172868.5

(51) Int. Cl. C08K 3/38

(52) U.S. Cl. CPC C08K 3/38; C08K 2003/385

(57) ABSTRACT

The invention relates to a component part produced by thermoplastic processing, having a wall thickness of at most 3 mm on at least one part of the component part, wherein the component part comprises a thermoplastically processable polymer material and a thermally conductive filler, wherein the filler comprises boron nitride agglomerates. The invention furthermore relates to a polymer/boron nitride compound for producing such a component part. The invention furthermore relates to the use of such a component part for heat dissipation from component parts or assemblies to be cooled.

The present invention relates to a component part produced by thermoplastic processing of a polymer compound using stable boron nitride agglomerates having high through-plane thermal conductivity, a polymer/boron nitride compound for producing such component parts and the use of such component parts for heat dissipation.

Thermoplastically processable plastics are used in a wide variety of applications. For that purpose the properties of the base polymer are often modified by compounding with additional components and are thereby customized for each application.

Organic, mineral, ceramic, vitreous and metallic fillers, for example, may be used as additional components for compounding with the polymer matrix. The additional components may be used, for example, to modify the mechanical or electrical properties, the coefficient of thermal expansion, or the density, or to increase thermal conductivity.

During compounding, a mixed material consisting of polymers and the additional components forms, which typically accumulates in the form of granules, and which is further processed in shaping processes. Shaping to form component parts is preferably carried out by injection molding.

To produce heat-conductive polymer-based mixed materials, heat-conductive fillers are introduced into the oftentimes only poorly heat-conductive thermoplastic matrix. Hexagonal boron nitride is a highly heat-conductive filler having a platelet-shaped particle morphology, which may be used for producing heat-conductive polymer/boron nitride mixed materials (polymer/boron nitride compounds).

When compounding thermoplastically processable polymers with fillers, extruders are generally used. Twin-screw extruders are used, for example, in which the screws assume further functions in addition to transporting material. Depending on each application, different embodiments may use conveying elements, mixing elements, shearing elements such as, for example, kneading blocks, and backflow elements in different zones in the extruder. Mixing elements and shearing elements ensure good mixing and homogenization of polymer melt and filler.

Fillers may be added together with the polymers via the main hopper but also via side feeders. Adding the filler via side feeders is particularly important if the filler is sensitive to shearing. The polymer granules are dosed via the main feeder into the feed zone of the extruder and subsequently melted under high pressure and strong shearing. The shear-sensitive filler is added via a side feeder to the already melted polymer.

Fillers which are less sensitive to shearing may be added via additional side feeders already at an earlier point in time during additional side feedings or during the main feeding together with the polymer. Fillers that are less sensitive to shearing or fillers that must be thoroughly homogenized such as, for example, pigments, remain in the extruder longer and, from the point of where they were added, pass through all of the downstream homogenization and shearing areas in the extruder.

Depending on the selected compounding parameters such as, for example, screw speed and temperature, shear-sensitive fillers may undergo degradation or partial degradation.

At the end of the extruder, the compound leaves the extruder through nozzles as a polymer melt in the form of strands. After the strand cools and solidifies, a granulator produces compound granules which are intended for further processing in molding processes.

One possible shaping process for unfilled polymer granules and also for compound granules consisting of polymers and fillers, is injection molding. The polymer granules or the compound granules are remelted in the injection molding machine and filled into a mold under high pressure. There, the polymer melt or compound melt solidifies, and the injection-molded component part can be ejected.

In injection molding, there is great freedom of design with respect to shaping, and complex component parts which may assume numerous functions can be injection-molded. By using fillers, the polymers are adapted to each application and function that they are to fulfill.

It has been shown that in the production of heat-conductive polymer/boron nitride compounds and their processing into component parts, many influencing factors have a significant effect on the thermal conductivity result. These influencing factors include compounding, shaping, sample geometry, sample drawing and the measuring method that is used.

During compounding, for example, co-kneading machines (Buss kneaders), single-screw extruders and twin-screw extruders may be used. Adjustments for rough or gentle compounding can be made via the machine design and/or process parameters. To adjust for relatively rough compounding, it is possible to use both dispersing and shearing elements such as, for example, kneading blocks; to adjust for more gentle compounding, kneading blocks, for example, may be dispensed with altogether. A higher screw speed leads to comparatively stronger shearing of the compound and the filler in the compound, while a lower screw speed leads to comparatively weaker shearing of the compound and the filler in the compound.

When compounding polymers with boron nitride powders, for example with spray-dried boron nitride powder, to form polymer/boron nitride compounds, it has been shown that when 30% by volume boron nitride is added to polyamide (PA 6), rough compounding with strong mixing and shearing and good dispersion of the filler leads to comparatively good mechanical properties of the compound, while thermal conductivity is comparatively lower. Conversely, gentle compounding with low shearing and poorer dispersion leads to compounds with comparatively better thermal conductivity and poorer mechanical properties.

Subsequent shaping also influences the thermal conductivity result. If samples of the polymer/boron nitride compound produced with rough compounding are produced by hot pressing, through-plane thermal conductivity is 40% higher than for tensile test bars produced from the same polymer/boron nitride compound by injection molding. The through-plane thermal conductivity values of the hot-pressed samples are up to 100% higher than those measured on 2 mm thin injection-molded plates. If thin plates having a thickness of 2 mm are produced by injection-molding with the polymer/boron nitride compound produced by gentle compounding, through-plane thermal conductivity is up to 15% higher than that of the injection-molded 2 mm plates from the compound produced by rough compounding.

Sample geometry furthermore also influences the thermal conductivity result. The through-plane thermal conductivity measured on the injection-molded tensile bar having a thickness of 4 mm is up to 50% higher than the through-plane thermal conductivity measured on the injection-molded 2 mm thick plates.

In injection molding, the type of sample drawing also influences the thermal conductivity result. It has been shown, for example, that in rough compounding and injection molding of 2 mm thin plates, the thermal conductivity may differ strongly close to the gate, in the middle of the sample and away from the gate. For instance, the thermal conductivity in high-fill compounds may deviate by as much as 20% depending on the position of the sample draw. In rough compounding and injection molding of tensile test bars, the thermal conductivity of a sample taken close to the gate directly after the first sample shoulder may deviate by as much as 10% from a sample taken away from the gate before the second sample shoulder.

Finally, the measuring method also influences the through-plane thermal conductivity result. If through-plane thermal conductivity is measured using the hot disk method on 4 mm thick injection-molded plates, the measurement result in isotropic fillers is higher by approximately 15-20% than in measurements using the laser-flash method on 2 mm thin injection-molded plates, while up to 50% higher thermal conductivity is measured in platelet-shaped fillers using the hot disk method.

For these reasons, results from thermal conductivity measurements can only be directly compared if the production of the compound, shaping of the compound granules, sample drawing and thermal conductivity measurements are carried out under identical conditions.

Hexagonal boron nitride powder particles that are present as primary particles and not as agglomerates of primary particles have anisotropic thermal conductivity. Well-crystallized boron nitride powder has a platelet-shaped particle morphology. The boron nitride platelets typically have an aspect ratio, that is, a ratio of platelet diameter to platelet thickness, of >10. The thermal conductivity through the platelet is low compared with the thermal conductivity in the plane of the platelet.

If compounds are produced from a thermoplastic polymer and boron nitride powder in the form of platelet-shaped primary boron nitride particles, the primary boron nitride particles exist mainly in finely dispersed form. If such a compound is injection-molded, the majority of the platelet-shaped primary boron nitride particles, in particular in thin-walled component parts, align themselves plane-parallel to the surface of the injection mold and plane-parallel to the surface of the component part. The alignment of the platelet-shaped primary boron nitride particles occurs due to a shear rate in the injection-molded component part between the regions close to the mold wall and those farther away from it. The alignment of the platelet-shaped primary boron nitride particles in the injection-molded component part leads to an anisotropy of properties, in particular thermal conductivity. The thermal conductivity in thin-walled component parts having a wall thickness of ≦3 or ≦2 mm in the flow direction of the polymer compound (in-plane) is generally over four times greater, and the thermal conductivity through the component-part wall (through-plane) is up to seven times greater and more at filler loadings of ≧30% by volume. Anisotropy in the thermal conductivity of thermoplastic injection-molded component parts is a disadvantage in many applications. Heat dissipation through a housing wall, for example, is likewise low at low through-plane thermal conductivity. In applications using injection-molded housings, this property is disadvantageous since rapid distribution of heat in the housing wall is possible, but heat dissipation through the housing wall is not. Through-plane thermal conductivity that is as high as possible is desirable for these applications, in particular if heat should be dissipated across a two-dimensional area.

With filler loadings of below 50% by volume boron nitride powder in the compound, a value of 1 W/m*K for the through-plane thermal conductivity in injection-molded, thin-walled component parts having wall thicknesses of 2 mm and below is generally not exceeded.

Boron nitride may also be used in the form of agglomerates of platelet-shaped primary particles as a heat-conducting filler in polymers. Different methods for producing boron nitride agglomerates, for example by means of spray-drying, isostatic pressing, or pressing and subsequent sintering are described in US 2006/0 127 422 A1, WO 03/013 845 A1, U.S. Pat. No. 6,048,511, EP 0 939 066 A1, US 2002/0 006 373 A1, US 2004/0 208 812 A1, WO 2005/021 428 A1, U.S. Pat. No. 5,854,155 and U.S. Pat. No. 6,096,671.

When boron nitride agglomerates of this type are used, strong degradation of the boron nitride agglomerates takes place during compounding in the twin screw extruder and/or during injection molding, that is, a predominant proportion of the agglomerate breaks up into primary boron nitride particles or into agglomerate fragments, which can lead to large fluctuations and particularly to a reduction in the z-thermal conductivity of injection-molded plates, depending on the process conditions. This problem is mentioned in “Boron Nitride in Thermoplastics: Effect of loading, particle morphology and processing conditions” (Chandrashekar Raman, Proceedings of the NATAS Annual Conference on Thermal Analysis and Applications (2008), 36th 60/1-60/10).

In this investigation, platelet-shaped and agglomerated boron nitride powder was compounded with a thermoplastic polymer (Dow 17450 HDPE). The compounding was carried out in a twin screw extruder (Werner & Pfleiderer ZSK-30, L/D ratio 28.5, 2 mm nozzle) at a temperature of 190° C. and a screw speed of 100 RPM.

When spherical PTX60 boron nitride agglomerates (Momentive Performance Materials, average agglomerate size d50=60 μm) were used in the HDPE compound, it was shown that the use of a standard screw configuration with two mixing zones leads to greater degradation of the PTX-60 agglomerates than the use of a modified screw with only one mixing zone. This becomes particularly obvious at filler loadings of 39% by volume (60% by weight). The through-plane thermal conductivity measured on the injection-molded tensile bar sample of the compound produced with relatively rough processing was found to have a value that was approximately 25% lower (1.5 instead of 2.05 W/m*K) than the sample for which the gentler configuration was used during compounding. When thin, 1-mm-thick plates instead of 3.2 mm thick tensile bars are injection molded from the compound produced with the standard screw configuration, the through-plane thermal conductivity decreases from 1.5 W/m*K to 0.85 W/m*K with a filler loading of 39% by volume (60% by weight). The thermal conductivity with this type of processing is similarly low as when PT120 primary particles are used in the compound with the same filler loading. The authors attribute this reduction in thermal conductivity to the degradation of the BN agglomerates.

In the experiments described, it was shown that the employed boron nitride agglomerates disintegrate in the compounding process, or in the injection molding process, to such an extent that they are largely present in the injection-molded compound in the form of primary particles, and that the agglomerate form cannot be used for high through-plane thermal conductivities in many applications, in particular when injection molding thin plates or housing walls.

DE 10 2010 050 900 A1 describes a method for producing textured boron nitride agglomerates in which the boron nitride platelets have a preferential orientation in the agglomerate.

The object addressed by the invention is therefore to provide thermoplastically processable polymer/boron nitride compounds with which, at high levels of process reliability, high through-plane thermal conductivity values and high in-plane thermal conductivity values can be obtained in thin-walled component parts while overcoming the disadvantages of the prior art.

The above-mentioned object is achieved with the component part according to claim 1, the polymer/boron nitride compound according to claim 18, and the use of the component part according to claim 19. Preferred or particularly functional embodiments of the component part are specified in dependent claims 2 to 17 and in points 2 to 32.

Thus, the subject matter of the invention is a component part produced by thermoplastic processing having a wall thickness of at most 3 mm on at least one part of the component part, in which the component part comprises a thermoplastically processable polymer material and a thermally conducting filler, the filler comprising boron nitride agglomerates.

A further subject matter of the invention is a polymer/boron nitride compound for producing such a component part, wherein the polymer/boron nitride compound comprises a thermoplastically processable polymer material and a thermally conducting filler, the filler comprising boron nitride agglomerates.

A further subject matter of the invention is the use of such a component part for heat dissipation from component parts or assemblies that are to be cooled, preferably from electronic component parts or assemblies.

The polymer/boron nitride compounds according to the invention are capable of overcoming the disadvantages of low through-plane thermal conductivity of injection-molded, thin-walled component parts made from polymer/boron nitride compounds.

Through-plane thermal conductivity is the thermal conductivity measured in the through-plane direction, that is, perpendicular to the plate plane. In-plane thermal conductivity is the thermal conductivity measured in the in-plane direction, that is, along the plate plane.

Surprisingly, it has been shown that the through-plane thermal conductivity of the injection-molded, thin-walled component parts can be significantly increased with the polymer/boron nitride compounds according to the invention, while good in-plane thermal conductivity is maintained at the same time.

When using the same proportion of boron nitride, it is possible to achieve higher thermal conductivity values in the component parts according to the invention with the boron nitride agglomerates than with non-agglomerated boron nitride powders. Using the boron nitride agglomerates, it is possible to achieve higher filler loadings in boron nitride polymer compounds and in component parts produced therefrom, than with non-agglomerated boron nitride powders.

Surprisingly, the polymer/boron nitride compound according to the invention can also be processed by means of comparatively rough compounding without strong degradation of the boron nitride agglomerates used. Even when the thin-wall component parts are injection molded, there is no strong degradation of the boron nitride agglomerates. The component parts according to the invention can be produced at high levels of process reliability with reproducible thermal conductivity properties and mechanical properties.

The boron nitride agglomerates used to produce the component parts according to the invention exhibit high agglomerate stability. Surprisingly, shearing on the mixing elements and on the shearing/dispersing elements during compounding in the twin-screw extruder does not result in a degrading, or in a complete degrading, of the boron nitride agglomerates used. Even at high filler loadings, which lead to high thermal conductivity in the component part and where the problem of filler degradation is particularly severe, the boron nitride agglomerates used do not strongly degrade, or only partially degrade, into primary particles or agglomerates fragments.

The polymer/boron nitride compounds according to the invention are advantageous in that they exhibit an anisotropy ratio of 1.5 to 4 when processed into thin plates having a thickness ≦3 mm. This is surprising since it would be expected that the thermal conductivity in compounds and injection-molded plates and component parts therefrom would be substantially isotropic when largely isotropic boron nitride agglomerates are used. Even in the case of rough compounding, this ratio is retained for injection-molded thin plates, even when a proportion of the agglomerates degrade.

Even when anisotropic platelet-shaped or scale-like boron nitride agglomerates are used that have an aspect ratio >10, the anisotropy ratio of 1.5 to 4 preferably obtained with injection-molded thin plates is surprising to a person skilled in the art. It would be expected that the platelet-shaped boron nitride agglomerates would align themselves in the thin plates, which would be accompanied by a reduction in the through-plane thermal conductivity to the benefit of an increased in-plane thermal conductivity and an increased anisotropy ratio.

The anisotropy ratio is significantly less than when well-crystallized platelet-shaped boron nitride powder is used.

The anisotropy ratio of the thermal conductivity of 1.5 to 4 is favorable for heat dissipation, in particular in thin plates or housing walls.

It was also not expected that the preferred anisotropic ratio of the thermal conductivity of 1.5 to 4 would be retained even when using filler combinations of boron nitride agglomerates and secondary fillers for the component parts according to the invention. This is surprising, since a person skilled in the art would have expected the anisotropic ratio to significantly decrease when using the substantially isotropic secondary fillers. It is furthermore surprising that both the through-plane thermal conductivity and the in-plane conductivity is higher with filler combinations consisting of boron nitride agglomerates and secondary fillers in injection-molded plates than the mathematically added values of the thermal conductivities of injection-molded plates made from the compounds of polymers with the individual components, that is, the compound consisting of polymer and boron nitride agglomerates, and the compound consisting of polymer and secondary filler.

When using filler combinations of boron nitride agglomerates and secondary fillers, it has surprisingly been shown that not only does the thermal conductivity increase significantly in the through-plane direction with the same proportion of boron nitride agglomerates when additional secondary fillers are used as compared to using boron nitride agglomerates alone, but there is also a strong increase in the in-plane direction at the same time.

It is furthermore surprising that polymer/boron nitride compounds with filler loadings of thermally conducting fillers and reinforcing fillers that are not too high may be used for producing the component parts according to the invention. To further adjust the properties of the filled polymer materials, it is therefore possible to add further additives and fillers, so that in most standard thermoplastic polymers, total filler loadings of ≦50% by volume are possible and in TPE polymers (thermoplastic elastomers), for example, levels of ≦70% by volume.

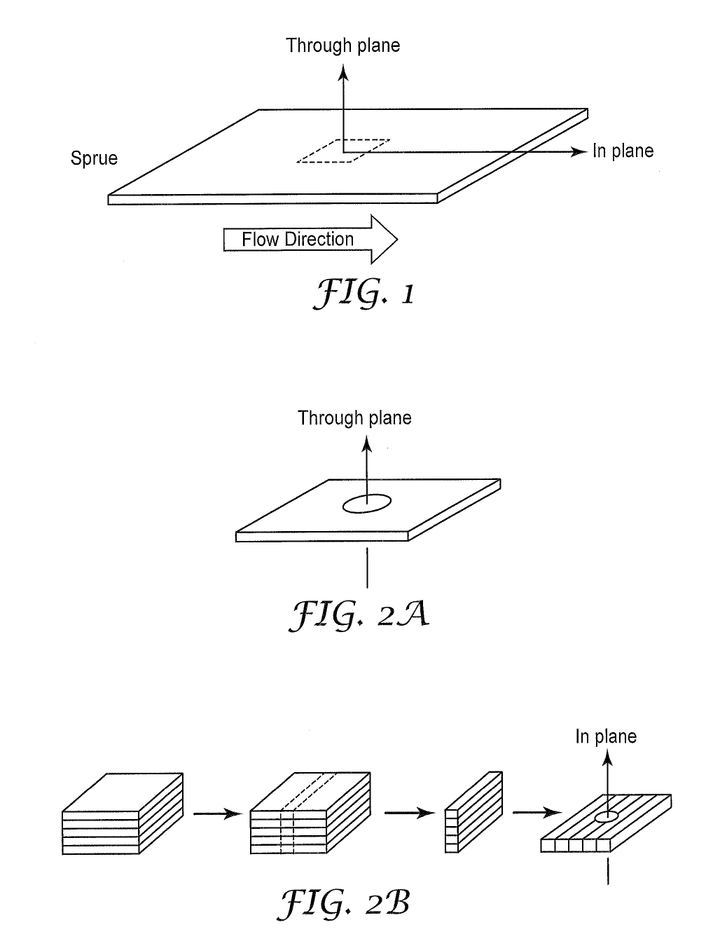

FIG. 1 shows a thin, injection-molded plate having the dimensions 80×80×2 mm³ with the sprue and in-plane and through-plane directions, in which the thermal conductivity values (in-plane thermal conductivity and through-plane thermal conductivity) are calculated.

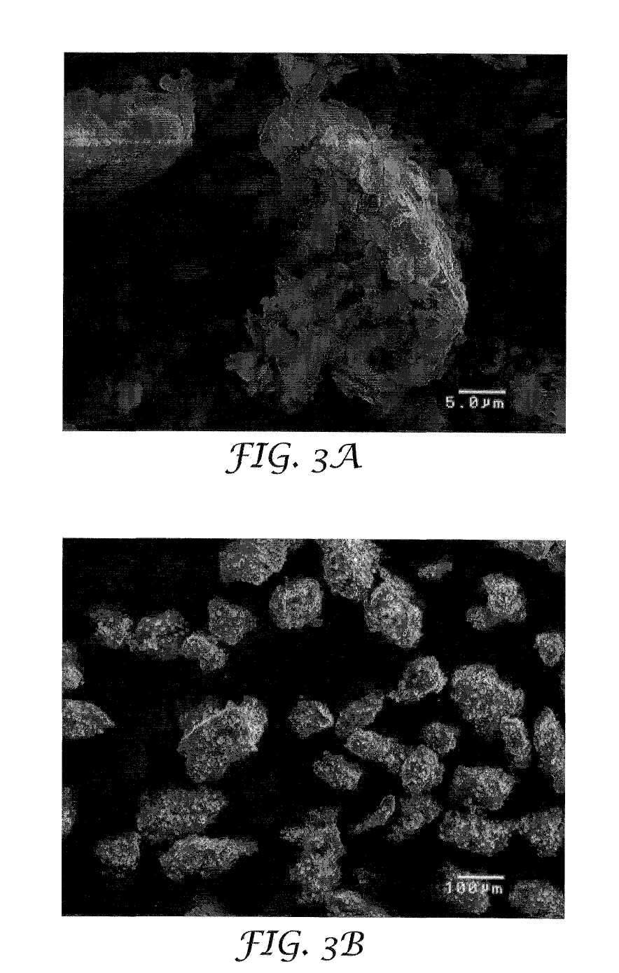

FIGS. 2a and b show the samples that were used for measuring through-plane and in-plane thermal conductivity. FIG. 2a shows a sample having the dimensions 10×10×2 mm³ which was prepared from the center of the injection-molded plate of FIG. 1 and which was used for measuring through-plane thermal conductivity. FIG. 2b shows the preparation of a sample for measuring in-plane thermal conductivity. First, a plate stack of samples having the dimensions 10×10×2 mm³ was produced by gluing using instant glue, wherein said samples consisting of injection-molded plates having the dimensions 80×80×2 mm³ were prepared. From the plate stack, a sample is prepared parallel to the through-plane direction and perpendicular to the flow direction of the injection-molded plates. On this sample, in-plane thermal conductivity is determined.

FIGS. 3a and 3b show SEM (Scanning Electron Microscope) images of the boron nitride agglomerates from example 18 that were used for the component parts and polymer/boron nitride compounds according to the invention. FIG. 3a shows an SEM image of a boron nitride agglomerate having an agglomerate diameter of 25 μm which is built up from many individual platelet-shaped primary boron nitride particles, as well as the fines not removed by screening and remaining in the product. FIG. 3b shows the 100-200 μM sieve fraction that was used to determine agglomerate stability.

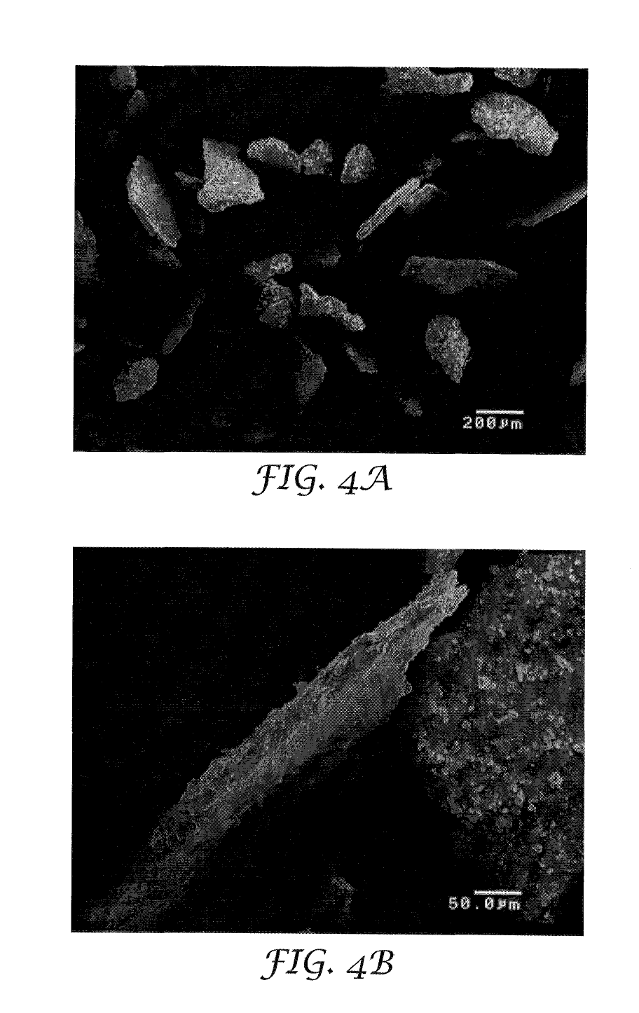

FIGS. 4a and 4b show SEM images of the boron nitride agglomerates from example 1 that were used for the component parts and polymer/boron nitride compounds according to the invention. FIG. 4a shows an overview image of the boron nitride agglomerates in the sieve fraction <500 μm. FIG. 4b shows a fractured surface of an agglomerate having a thickness of 30 μm.

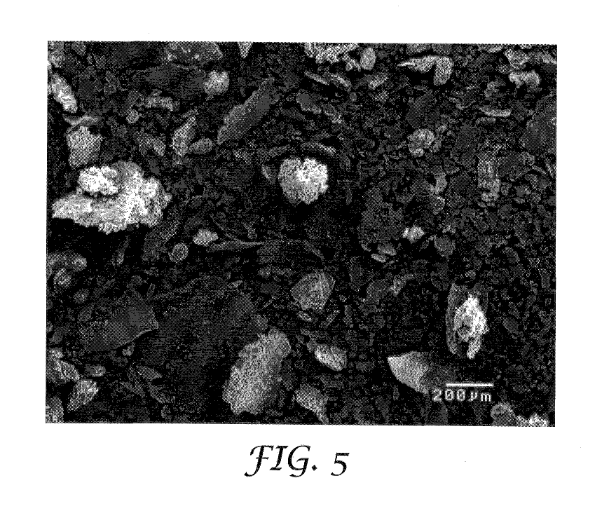

FIG. 5 shows a SEM overview image of the boron nitride agglomerates used for the component parts and polymer/boron nitride compounds according to the invention in the sieve fraction <500 μm from example 29. The thickness of the boron nitride agglomerates is 10 μm.

As already stated above, the through-plane thermal conductivity is the thermal conductivity measured in the through-plane direction, that is, perpendicular to the plate plane. In-plane thermal conductivity is the thermal conductivity measured in the in-plane direction, that is, in the plate plane.

The through-plane thermal conductivity of the component parts and polymer/boron nitride compounds according to the invention is preferably at least 1 W/m*K, more preferably at least 1.2 W/m*K, even more preferably at least 1.5 W/m*K, and particularly preferably at least 1.8 W/m*K. Thermal conductivity is measured according to DIN EN ISO 22007-4 on disk-shaped, injection-molded samples having a thickness of 2 mm.

The in-plane thermal conductivity of the component parts and polymer/boron nitride compounds according to the invention is preferably at least 1.5 W/m*K, more preferably at least 1.8 W/m*K, even more preferably at least 2.2 W/m*K and particularly preferably at least 2.7 W/m*K.

For measuring in-plane thermal conductivity, disk-shaped injection-molded samples having a thickness of 2 mm are stacked one on top of the other and glued together. From the plate stack thus prepared, a 2 mm thin sample having the dimensions of 2×10×10 mm³ is prepared parallel to the through-plane direction and perpendicular to the flow direction of the injection-molded plates. In-plane thermal conductivity is measured according to DIN EN ISO 22007-4 on the 2 mm thick sample thus prepared.

The anisotropy ratio of the in-plane thermal conductivity to the through-plane thermal conductivity of the component parts and boron nitride/polymer compounds according to the invention is preferably at least 1.5 and at most 4, more preferably at least 1.5 and at most 3.5, even more preferably at least 1.5 and at most 3.0, and particularly preferably at least 1.5 and at most 2.5.

The anisotropy ratio is calculated by taking the in-plane thermal conductivity determined as described and dividing it by the through-plane thermal conductivity measured as described.

The through-plane thermal conductivity of the component part and polymer/boron nitride compound according to the invention is preferably at least 0.8 W/m*K, more preferably at least 1 W/m*K, even more preferably at least 1.3 W/m*K, and particularly preferably at least 1.6 W/m*K greater than the thermal conductivity of the polymer material without thermally conducting filler.

The in-plane thermal conductivity of the component part and polymer/boron nitride compound according to the invention is preferably at least 1.3 W/m*K, more preferably at least 1.6 W/m*K, even more preferably at least 2.0 W/m*K, and particularly preferably at least 2.5 W/m*K greater than the thermal conductivity of the polymer material without thermally conducting filler.

The proportion of boron nitride agglomerates in the component part and polymer/boron nitride compound according to the invention is preferably at least 5% by volume, more preferably at least 10% by volume, more preferably at least 20% by volume, and particularly preferably at least 30% by volume, based on the total volume of the polymer/boron nitride compound.

The proportion of boron nitride agglomerates in the component part and polymer/boron nitride compound according to the invention is preferably not more than 70% by volume, more preferably not more than 60% by volume, and particularly preferably not more than 50% by volume, based on the total volume of the polymer/boron nitride compound.

Thermoplastically processable polymers are used as the polymers for the component part and polymer/boron nitride compound according to the invention. These are in particular the thermoplastic materials polyamide (PA), polyphenylene sulfide (PPS), polycarbonate (PC), polypropylene (PP), thermoplastic elastomers (TPE), thermoplastic polyurethane elastomers (TPU), and polyether ether ketones (PEEK), liquid crystal polymers (LCP), and polyoxymethylene (POM). Duroplastic molding materials that can be thermoplastically processed may also be used as the polymers.

The boron nitride agglomerates that are used for the component part and polymer/boron nitride compound according to the invention have high agglomerate stability. Boron nitride agglomerates having high agglomerate stability degrade only partially to primary particles or agglomerate fragments even under the influence of high shear forces, such as those occurring when the polymers are compounded together with the boron nitride fillers, in particular those polymers having high filler loadings. The advantageous properties of the polymer/boron nitride compound according to the invention, in particular the anisotropic ratio, are maintained, despite partial degradation.

The stability of the agglomerates can be tested, for example, in ultrasound experiments while simultaneously measuring the agglomerate size by laser granulometry, wherein the agglomerate disintegrates over time due to the effect of the ultrasound. The disintegration of the agglomerates is recorded via the change in agglomerate size over time, wherein different curves form depending on the stability of the agglomerate. Soft agglomerates disintegrate faster than mechanically more stable agglomerates.

For measuring agglomerate stability, boron nitride agglomerates smaller than 200 μm are broken up, and the fines <100 μm are removed by sieving. On the 100-200 μm sieve fraction thus obtained, agglomerate stability is determined by means of a laser granulometer (Mastersizer 2000 with dispersing unit Hydro 2000S, Malvern, Herrenberg, Germany). To this end, a solution consisting of a wetting agent in water (mixture of 2 mL of a rinsing agent (G 530 Spülfix, BUZIL-Werk Wagner GmbH & Co. KG, Memmingen) and 0.375 mL Imbentin (polyethylene glycol alkyl ether) in 10 L distilled water) is used as the dispersing medium. In a vial with snap-on cap (8 mL), 10-20 mg of the agglomerates is dispersed with 6 mL of the dispersing medium by shaking. Suspension is removed from the sample with a pipette and dropped into the wet cell of the laser granulometer until the laser obscuration reaches 5% (specific range: 5-30%). Measurement starts without ultrasound, and every 15 seconds, a further measurement is taken with ultrasound, in which the ultrasonic power of the dispersing unit (which can be set via the device software to values between 0 and 100%) is set to 5% of the maximum power in each case. A total of ten measurements is taken. When measuring, the stirrer of the dispersing unit runs at 1750 RPM. The quotient of the d₉₀ value after the ten measurements and the d₉₀ value of the first measurement is used (multiplied by 100 to express in percent) as a measure of agglomerate stability. The measuring method described here is also referred to hereafter as “ultrasound method.”

Agglomerate stability for the boron nitride agglomerates that are used for the polymer/boron nitride compounds according to the invention and the component parts according to the invention is preferably at least 40%, more preferably at least 50%, particularly preferably at least 60%. In this case, agglomerate stability is determined using the above-described ultrasound method.

The specific surface (BET) of the scale-like boron nitride agglomerates that are preferably used for the polymer/boron nitride compounds according to the invention and the component parts according to the invention is preferably 20 m²/g or less, more preferably 10 m²/g or less.

The boron nitride agglomerates that are used for the polymer/boron nitride compounds according to the invention and the component parts according to the invention are pourable and easy to dose, in contrast to non-agglomerated boron nitride powders.

In a preferred embodiment of the component part and polymer/boron nitride compound according to the invention, largely isotropic nitride-bonded boron nitride agglomerates are used as the boron nitride agglomerates. These boron nitride agglomerates are agglomerates of platelet-shaped hexagonal primary boron nitride particles in which the hexagonal primary boron nitride particles are bonded to one another by means of an inorganic binder phase. The inorganic binder phase comprises at least one nitride and/or oxynitride. The nitrides and oxynitrides are preferably compounds of the elements aluminum, silicon, titanium, and boron. These boron nitride agglomerates may also be referred to as isotropic nitride-bonded boron nitride agglomerates or isotropic boron nitride agglomerates with a nitride binder phase. The boron nitride platelets in these agglomerates are essentially oriented without a preferred direction with respect to one another, which means that they essentially have isotropic properties. The isotropic nitride-bonded boron nitride agglomerates are also referred to below as boron nitride hybrid agglomerates.

For producing such nitride-bonded isotropic boron nitride agglomerates, boron nitride feedstock powder in the form of primary boron nitride particles or amorphous boron nitride is mixed with binder phase raw materials, processed into granules or shaped pieces, and these are then treated at a temperature of at least 1,600° C. in a nitriding atmosphere, and the obtained granules or shaped pieces are then comminuted and/or fractionated if applicable.

The nitrides and oxynitrides contained in the binder phase are preferably aluminum nitride (AlN), aluminum oxynitride, titanium nitride (TiN), silicon nitride (Si₃N₄) and boron nitride (BN), preferably aluminum nitride, aluminum oxynitride, titanium nitride and/or silicon nitride, further preferably aluminum nitride and/or aluminum oxynitride. The binder phase particularly preferably contains aluminum nitride.

The nitrides and oxynitrides of the binder phase may be amorphous, partially crystalline or crystalline. The binder phase is preferably crystalline.

The nitride binder phase may also contain oxide phases such as boron oxide (B₂O₃), aluminum oxide (Al₂O₃), silicon dioxide (SiO₂), titanium dioxide (TiO₂), yttrium oxide (Y₂O₃), magnesium oxide (MgO), calcium oxide (CaO) and rare earth metal oxides.

Furthermore, the binder phase may also contain borates such as aluminum borates or calcium borates. In addition, the binder phase may also contain impurities such as carbon, metal impurities, elementary boron, boride, boron carbide or other carbides such as silicon carbide.

The proportion of nitride binder phase in the nitride-bonded isotropic boron nitride agglomerates is preferably at least 1% by weight, more preferably at least 5% by weight, even more preferably at least 10% by weight, even more preferably at least 20% by weight, and particularly preferably at least 30% by weight based on the total amount of boron nitride agglomerates.

The proportion of nitrides and oxynitrides in the binder phase is preferably at least 50% by weight, and particularly preferably at least 80% by weight based on the total binder phase.

The binder phase bonds the primary boron nitride particles in the agglomerates so that more mechanically stable agglomerates can be obtained in comparison to binder-free agglomerates.

The nitride-bonded isotropic boron nitride agglomerates may be round to spherical or blocky and angular depending on the production method. The agglomerates produced by spray drying retain their round to spherical shape even after nitridation. Agglomerates produced by means of compacting and comminution tend to have a blocky or chunky, angular or edged shape.

When producing the polymer/boron nitride compounds according to the invention, the nitride-bonded isotropic boron nitride agglomerates that are preferably used have an average agglomerate diameter (d₅₀) of ≦1000 μm, more preferably ≦500 μm, even more preferably ≦400 μm, even more preferably ≦300 μm, and even more preferably ≦200 μm. The average agglomerate diameter (d₅₀) can be determined by means of laser diffraction (wet measurement, Mastersizer 2000, Malvern). The average agglomerate diameter is at least two times greater than the average particle size of the primary boron nitride particles that are used in the agglomerate production, preferably at least three times greater. The average agglomerate diameter may also be ten times or also fifty times or more greater than the average particle size of the primary boron nitride particles that are used in the agglomerate production. The average particle size of the primary particles (d₅₀) in the nitride-bonded isotropic nitride agglomerates is ≦50 μm, preferably ≦30 μm, more preferably ≦15 μm, even more preferably ≦10 μm and particularly preferably ≦6 μm.

The nitride-bonded isotropic boron nitride agglomerates used in compounding the polymer/boron nitride compounds have an aspect ratio of 1.0 to 1.8, preferably 1.0 to 1.5.

The nitride-bonded isotropic boron nitride agglomerates are boron-nitride agglomerates of a high density.

Direct contact points exist between the individual platelet-shaped primary boron nitride particles in the nitride-bonded isotropic boron nitride agglomerates, resulting in continuous thermal conduction pathways in the boron nitride agglomerates, consisting of primary boron nitride particles.

Hexagonal boron nitride, amorphous boron nitride, partially crystalline boron nitride and mixtures thereof may be used as the boron nitride feedstock powder for producing the nitride-bonded isotropic boron nitride agglomerates.

The average particle size (d₅₀) of the boron nitride powder that is used may be 0.5-50 μm, preferably 0.5-15 μm, and more preferably 0.5-5 μm. For instance, hexagonal boron nitride powders having an average particle size of 1 μm, 3 μm, 6 μm, 9 μm and 15 μm may be used, but greater average particle sizes of up to 50 μm are also possible. Mixtures of different hexagonal boron nitride powders having different particle sizes may likewise be used. Measuring the average particle size (k) of the boron nitride powders that are used is typically carried out by means of laser diffraction (wet measurement, Mastersizer 2000, Malvern).

B₂O₃-free boron nitride powders and boron nitride powders with lower B₂O₃ contents of up to 0.5% by weight, but also with higher B₂O₃ contents of up to 10% by weight and more, may be used.

The binder phase raw materials may be present in solid or liquid or paste-like form.

Mixing boron nitride feedstock powder and binder phase raw materials may be carried out in a mixing drum, in a V-mixer, a drum hoop mixer, a vibrating tube mill or an Eirich mixer, for example. Homogeneity may be further increased in a subsequent milling step, for example in a crossbeater mill, tumbling mill or agitator bead mill. The powder mixture may be dry or moistened. It is likewise possible to add pressing aids and, if necessary, lubricating aids. Mixing may also be carried out wet, for example, if the subsequent production of the granules is carried out via spray-drying or build-up granulation.

Metal compounds in combination with reducing agents may also be used as binder phase raw materials for producing the nitride binder phase, the nitride binder phase being produced by via reduction nitridation. The metal compounds used are preferably compounds from the elements aluminum, silicon and titanium, preferably oxides and/or hydroxides such as aluminum oxide (Al₂O₃), aluminum hydroxide (Al(OH)₃), boehmite (AlOOH), silicon dioxide (SiO₂) and titanium dioxide (TiO₂). The metal compounds may also be borates such as aluminum borate. Carbon and hydrogen as well as organic compounds such as, for example, polyvinyl butyral (PVB), melamine and methane may be used as reducing agents. If gaseous substances such as, for example, hydrogen or methane are used as reducing agents, these substances are added to the nitriding atmosphere. The reducing agent necessary for the reduction may also already exist in the metal compound, thus making the use of additional reducing agents unnecessary, for example when using aluminum isopropoxide, tetraethylorthosilicate or titanium isopropoxide as binder raw materials. In the nitriding step, the metal compounds are converted into the corresponding metal nitrides. It is also possible that oxynitrides or mixtures of metal nitrides and oxynitrides form during nitridation; likewise, the binder phase may still contain residual unreacted oxides.

Reactants for producing boron nitride may also be used as binder phase raw materials for producing the nitride binder phase of the anisotropic nitride-bonded boron nitride agglomerates. The reactants for producing boron nitride may contain an oxidic boron source such as, for example, boric acid (H₃BO₃) and boron oxide (B₂O₃) in combination with a reducing agent such as, for example, carbon or hydrogen or organic compounds such as polyvinyl alcohol (PVA), polyvinyl butyral (PVB), melamine and methane. If gaseous substances such as, for example, hydrogen or methane are used as reducing agents, these substances are added to the nitriding atmosphere. Substantially oxygen-free boron sources such as, for example, elemental boron, boron carbide and trimethyl borate may also be used as reactants for producing boron nitride. In the nitriding step, these raw materials are converted to hexagonal boron nitride.

The binder phase raw materials used for producing the nitride binder phase of the anisotropic nitride-bonded boron nitride agglomerates may also be nitride materials which solidify during the heat treatment in the nitriding atmosphere. The nitride material may be a nitride and/or oxynitride compound of aluminum or silicon, but titanium nitride and rare earth nitrides may also be used; likewise, compounds from the group consisting of sialons. Liquid phases such as, for example, yttrium oxide, aluminum oxide, magnesium oxide, calcium oxide, silicon oxide and rare earth oxides may be used as sintering aids.

It is also possible to use mixtures of the different binder phase raw materials listed.

In a subsequent comminution and/or fractionation step, the shaped pieces or granules are comminuted or fractionated if necessary after the heat treatment in the nitriding atmosphere to the desired agglomerate size to thereby produce the nitride-bonded agglomerates according to the invention. If the final agglomerate size was achieved already during the granulation of the raw materials, for example if granulation was carried out by spray drying or build-up granulation, the comminution step following nitriding does not take place.

To achieve the target agglomerate size of the nitride-bonded isotropic boron nitride agglomerates, customary steps such as screening, screen fractioning and sifting may be taken. If fines are contained, they may be removed first. As an alternative to screening, the defined comminution of the agglomerates can also be carried out with sieve graters, classifier mills, structured roller crushers and cutting wheels. Grinding, for instance in a ball mill, is also possible.

Following their production, the nitride-bonded isotropic boron nitride agglomerates may be subjected to further treatments. In this case, for example, one or more of the following possible treatments may be carried out:
heat treatment under oxygen that leads to surface oxidation of the nitride-bonded isotropic boron nitride agglomerates. For instance, agglomerates with superficial TiO₂ can be produced with a binder phase containing titanium nitride (TiN) by oxidation in air above at 500° C.; superficial SiO₂ can be produced with a binder phase containing silicon nitride (Si₃N₄), and superficial aluminum oxide (Al₂O₃) can be produced with a binder phase containing aluminum nitride (AlN).
a steam treatment
a surface modification with silanes, titanates or other organometallic compounds, either at room temperature or under the effect of heat and with carrier or reaction gases. This surface modification also increases the hydrolysis resistance of the nitride binder phase.
a surface modification with polymers, for example with polyethylene glycol (PEG), polyvinyl alcohol (PVA), polyvinyl butyral (PVB), polyvinyl pyrrolidone (PVP), copolymers, acrylates, oils or carboxylic acids.
an infiltration with sol gel systems, for example with boehmite sol or SiO₂ sol, or with water-soluble glasses or nanoparticles, or surface-modified nanoparticles or mixtures thereof.
an infiltration with water or ethanol-soluble polymers. The boron nitride agglomerates may be infiltrated with resins such as, for example, silicone, epoxy or polyurethane resins, and the resins may be hardened with hardener or be heat-hardened before or during compounding.

The listed surface treatments may also be carried out for mixtures of nitride-bonded isotropic boron nitride agglomerates with other boron nitride fillers such as, for example, primary boron nitride particles.

It is also possible to combine several of the listed treatments in any order. For example, the treatments may be carried out in a fluidized bed method.

With the listed treatments, it is possible to achieve an improved coupling of the polymer matrix to the nitride-bonded isotropic agglomerates.

Under otherwise comparable processing conditions, the through-plane thermal conductivity of nitride-bonded isotropic boron nitride agglomerates may be increased by more than 40% with a filler loading of 30% by volume, and by more than 70% with a filler loading of 40% by volume, in comparison to using non-agglomerated platelet-shaped boron nitride. It is particularly surprising that these increases are also achieved with rough compounding in a twin-screw extruder and when injection molding thin plates.

In a further preferred embodiment of the component part and polymer/boron nitride compound according to the invention, substantially anisotropic scale-like boron nitride agglomerates are used as the boron nitride agglomerates. These boron nitride agglomerates are agglomerates comprising platelet-shaped hexagonal primary boron nitride particles which are agglomerated together to form scale-like boron nitride agglomerates. These boron nitride agglomerates may also be referred to as scale-like boron nitride agglomerates or boron nitride flakes. These boron nitride flakes should be distinguished from non-agglomerated platelet-shaped primary boron nitride particles, which are often referred to as “flaky boron nitride particles” in the English-language literature. The structure of the scale-like boron nitride agglomerates is built up from many individual boron nitride platelets. The platelet-shaped primary boron nitride particles in these agglomerates are not randomly oriented toward one another. The scale-like boron nitride agglomerates comprise platelet-shaped primary boron nitride particles, the platelet planes of which are aligned parallel to one another. The platelet-shaped primary boron nitride particles are preferably agglomerated together in such a way that the platelet planes of the primary boron nitride particles are aligned substantially parallel to one another. The scale-like boron nitride agglomerates have anisotropic properties since the platelet-shaped primary boron nitride particles in these agglomerates are not randomly oriented toward one another.

The degree of alignment of the platelet-shaped primary boron nitride particles in the anisotropic scale-like boron nitride agglomerates can be characterized with the texture index. The texture index of hexagonal boron nitride (hBN) with completely isotropic alignment of the platelet-shaped primary boron nitride particles, that is, without a preference in any particular direction, is 1. The texture index rises with the degree of orientation in the sample, that is, the more platelet-shaped primary boron nitride particles are aligned on top of one another or parallel to one another with their basal surfaces, or the more platelet planes of the primary boron nitride particles are aligned parallel to one another. The texture index for the anisotropic scale-like boron nitride agglomerates that are used for the component parts according to the invention preferably lies at values of greater than 2.0, more preferably at 2.5 and more, even more preferably at 3.0 and more and particularly preferably at 3.5 and more. The texture index of the agglomerates may also have values of 5.0 and more and 10.0 and more. The texture index of the scale-like boron nitride agglomerates preferably lies at values of 200 and less, more preferably at values of 50 and less. The texture index is determined with X-ray radiography. To this end, the ratio of the intensities of the (002) and (100) diffraction reflexes is determined by measuring the X-ray diffraction diagrams and divided by the corresponding ratio for an ideal, non-textured hBN sample. This ideal ratio can be determined from the JCPDS data, and it is 7.29.

The texture index (TI) of the boron nitride agglomerates can thus be calculated according to the formula

$$TI = \frac{{I}_{( 002 ) , sample} / {I}_{( 100 ) , sample}}{{I}_{( 002 ) , theoretical} / {I}_{( 100 ) , theoretical}} = \frac{{I}_{( 002 ) , sample} / {I}_{( 100 ) , sample}}{7.29}$$

as the ratio I₍₀₀₂₎/I₍₁₀₀₎ of the intensities of the (002) and (100) diffraction reflexes of the X-ray diffraction diagram of the boron nitride agglomerates, divided by the number 7.29. The texture index of the boron nitride agglomerates is measured on bulk boron nitride agglomerates. The measurement is carried out at a temperature of 20° C.

If the texture index is determined on large scale-like individual agglomerates having a size of about 3.5 cm² (based on the area of the top or bottom surface of scale-like agglomerates), very high values of 100 and more and up to about 500 can be obtained for the texture index. These values that are measured on the large scale-like agglomerates are proof of very strong alignment of the primary particles in the scale-like boron nitride agglomerates. When measuring the texture index on the scale-like boron nitride agglomerates that are preferably used for the component parts and polymer/boron nitride compounds according to the invention, which is carried out on an agglomerate fill as already described above, partially static alignment takes place in the sample carrier for the X-ray radiographic measurement. The texture index values that are obtained on smaller scale-like agglomerates having a size of ≦1 mm is therefore always lower than the corresponding orientation of the primary particles in the individual scale-like agglomerate.

The texture index of the isotropic nitride-bonded agglomerates used for the component parts and boron nitride/polymer compounds according to the invention is preferably a value of 1.0 to <2.0.

In the polymer/boron nitride compounds and component parts according to the invention, the anisotropic scale-like boron nitride agglomerates that are preferably used have an average agglomerate diameter (d₅₀) of ≦1000 μm, more preferably ≦500 μm, even more preferably ≦300 μm and particularly preferably ≦200 μm. The average agglomerate diameter (d₅₀) of the anisotropic scale-like boron nitride agglomerates that are used in the polymer/boron nitride compound and the component parts according to the invention is preferably ≧20 μm, more preferably ≧30 μm, even more preferably ≧50 μm and particularly preferably ≧100 μm. The average agglomerate diameter (d₅₀) can be determined by means of laser diffraction (wet measurement, Mastersizer 2000, Malvern). The average agglomerate diameter is at least two times greater than the average particle size of the primary boron nitride particles that are used in the agglomerate production, preferably at least three times greater. The average agglomerate diameter may also be ten times or also fifty times or more greater than the average particle size of the primary boron nitride particles that are used in the agglomerate production. The average particle size of the primary particles (d₅₀) in the anisotropic scale-like boron nitride agglomerates is ≦50 μm, preferably ≦30 μm, more preferably ≦15 μm, even more preferably ≦10 μm and particularly preferably ≦6 μm.

The thickness of the anisotropic scale-like boron nitride agglomerates is ≦500 μm, preferably ≦200 μm, more preferably ≦100 μm, even more preferably ≦70 μm, still more preferably ≦50 μm and particularly preferably ≦35 μm. The thickness is at least 1 μm, more preferably ≧2 μm, even more preferably ≧3 μM and particularly preferably ≧5 μm. The thickness of the anisotropic scale-like boron nitride agglomerates can be determined using a digital precision gauge or a scanning electron microscope (SEM).

The aspect ratio, that is, the ratio of agglomerate diameter to agglomerate thickness of the scale-like boron nitride agglomerates can be determined with scanning electron microscope (SEM) images by measuring the diameter and thickness of the agglomerate. The aspect ratio of the scale-like agglomerates has a value of greater than 1, preferably values of 2 and more, more preferably values of 3 and more and particularly preferably values of 5 and more.

The anisotropic scale-like boron nitride agglomerates are boron nitride agglomerates of high density.

Direct contact points exist between the individual platelet-shaped primary boron nitride particles in the anisotropic scale-like boron nitride agglomerates, resulting in continuous heat conduction pathways in the boron nitride agglomerates, built up from primary boron nitride particles.

The scale-like boron nitride agglomerates that are used for the component parts and polymer/boron nitride compounds according to the invention have surfaces on their top and bottom sides that were produced directly by the shaping process and not by comminution. These surfaces are referred to hereafter as “shaped surfaces”. The shaped surfaces are comparatively smooth, in contrast to the rough side surfaces (fractured surfaces) of the agglomerates, which were created by fracturing or comminuting steps. The surfaces of the scale-like boron nitride agglomerates are substantially flat (planar), and their top and bottom sides are substantially parallel to one another.

The proportion of the shaped surface in the total surface area of the scale-like boron nitride agglomerates is on average at least 33% (if the diameter of the agglomerate is equal to its height) assuming a platelet or scale shape having a round base, and it is likewise at least 33% (if the agglomerates are cube-shaped) assuming a platelet or scale shape having a square base. For scale-like boron nitride agglomerates having a high aspect ratio, the proportion of the shaped surface in the total surface area is considerably higher; for agglomerates having an aspect ratio >3.0, the proportion is typically between 60 and 95%; for very large agglomerates, the proportion may be even higher. By rounding the agglomerates, or even as a consequence of a screening or sizing process, the proportion of the shaped surface in the total surface area may be reduced; however, the proportion is generally always at least 10%, preferably at least 20%.

The ratio of the shaped surface to the total surface area can be determined by analyzing SEM images. In doing so, the values calculated for agglomerate diameter and thickness are used to determine the aspect ratio. From these values, the proportion of the shaped surface in the total surface area is calculated as follows:

proportion of shaped surface [%]=((2*end face)/total surface area)*100

wherein
end face=agglomerate diameter*agglomerate diameter
total surface area=2*end phase+4*side face
side face=agglomerate thickness*agglomerate diameter

For producing the scale-like boron nitride agglomerates, boron nitride feedstock powder in the form of primary boron nitride particles or amorphous boron nitride, optionally mixed with binder phase raw materials, is processed into scale-like agglomerates in a shaping step and subsequently subjected to a heat treatments step, a high-temperature annealing, and the obtained scale-like agglomerates are subsequently comminuted and/or fractionated, if necessary.

The scale-like boron nitride agglomerates are shaped by compressing the dry or moistened powder mixture by uniaxial pressing or roller compacting.

For shaping, the boron nitride feedstock powder or the powder mixture consisting of boron nitride feedstock powder and binder phase raw materials is preferably compressed between two counter-rotating rollers. In the gap between the rollers, contact forces are set per cm of roll gap length of ≧0.5 kN, preferably ≧1 kN, more preferably ≧2 kN, even more preferably ≧3 kN, still more preferably ≧5 kN, most preferably ≧7 kN and particularly preferably ≧10 kN. The contact force of the rollers influences the density of the anisotropic scale-like boron nitride agglomerates. With high contact forces, a part of the boron nitride raw material is made amorphous, which recrystallizes during the subsequent high-temperature annealing. The production of the anisotropic scale-like boron nitride agglomerates may also take place when using micro-structured rollers.

The residual moisture of the produced agglomerates can be driven out prior to a further heat treatment or nitridation by drying at approximately 100° C.

The material that is compacted into scale-like agglomerates is subjected to a heat treatment step, a high-temperature annealing. If the scale-like agglomerates are produced without the addition of binder phase raw materials and only using boron nitride feedstock powders, that is, primary boron nitride particles or amorphous boron nitride, high-temperature annealing of the scale-like agglomerates is carried out at temperatures of at least 1600° C., preferably at least 1800° C.

If necessary, the obtained scale-like agglomerates may subsequently also be further comminuted and/or fractionated.

With increasing contact force during compaction and with increasing temperature during the heat treatment, the stability of the anisotropic scale-like boron nitride agglomerates increases, as does thermal conductivity, measured on thin plates having a thickness of 2 mm which were produced from polymer/boron nitride compounds according to the invention using the anisotropic scale-like boron nitride agglomerates.

When producing the anisotropic scale-like boron nitride agglomerates, boron nitride powders without further additives may be used and processed into the anisotropic scale-like boron nitride agglomerates. Mixtures consisting of hexagonal boron nitride powder and other powders are preferably used, thus producing anisotropic scale-like mixed agglomerates consisting of boron nitride and secondary phases (“boron nitride hybrid flakes”). The powders additionally added to the hexagonal boron nitride powder for producing the anisotropic scale-like mixed agglomerates may be binder phase raw materials for producing an inorganic binder phase. In the anisotropic scale-like mixed agglomerates, the hexagonal primary boron nitride particles are connected to one another by means of an inorganic binder phase as a secondary phase.

The inorganic binder phase of the anisotropic scale-like boron nitride mixed agglomerates comprises at least one carbide, boride, nitride, oxide, hydroxide, metal or carbon.

As in the binder phase-free anisotropic scale-like boron nitride agglomerates, the platelet-shaped primary boron nitride particles are not randomly oriented in these scale-like mixed agglomerates. The scale-like boron nitride mixed agglomerates comprise platelet-shaped primary boron nitride particles, the platelet planes of which are aligned parallel to one another. The platelet-shaped primary boron nitride particles are preferably agglomerated together in such a way that the platelet planes of the primary boron nitride particles are aligned substantially parallel to one another. The scale-like boron nitride mixed agglomerates have anisotropic properties since the platelet-shaped primary boron nitride particles in these agglomerates are not randomly oriented toward one another.

The binder phase in the anisotropic scale-like boron nitride mixed agglomerates (boron nitride hybrid flakes) is located between the primary boron nitride particles, but it may also be located, at least partially, on the surface of the boron nitride hybrid flakes or cover the majority of the surface area. The binder phase bonds the primary boron nitride particles in the boron nitride hybrid flakes, making it possible to obtain mechanically more stable agglomerates compared with binder-free agglomerates.

The anisotropic scale-like boron nitride mixed agglomerates preferably have a binder phase proportion of at least 1%, more preferably at least 5%, even more preferably at least 10%, still more preferably at least 20% and particularly preferably at least 30%, in each case based on the total amount of scale-like boron nitride agglomerates.

High-temperature annealing of the scale-like boron nitride agglomerates having an inorganic binder phase is carried out at temperatures of at least 1000°.

In a further preferred embodiment, the inorganic binder phase of the anisotropic scale-like mixed agglomerates comprises at least one nitride and/or oxynitride. The nitrides or oxynitrides are preferably compounds of the elements aluminum, silicon, titanium and boron.

These boron nitride mixed agglomerates may also be referred to as anisotropic nitride-bonded boron nitride agglomerates or anisotropic boron nitride agglomerates with nitride binder phase.

The nitrides and oxynitrides contained in the binder phase are preferably aluminum nitride (AlN), aluminum oxynitride, titanium nitride (TiN), silicon nitride (Si₃N₄) and/or boron nitride (BN), more preferably aluminum nitride, aluminum oxynitride, titanium nitride and/or silicon nitride, even more preferably aluminum nitride and/or aluminum oxynitride. The binder phase particularly preferably contains aluminum nitride.

The nitrides and oxynitrides of the binder phase may be amorphous, partially crystalline or crystalline. The binder phase is preferably crystalline, since this makes it possible to achieve higher thermal conductivity values in the polymer/boron nitride compounds according to the invention and the component parts according to the invention.

The binder phase containing nitrides and/or oxynitrides may additionally also contain oxide phases such as, for example, boron oxide (B₂O₃), aluminum oxide (Al₂O₃), silicon dioxide (SiO₂), titanium dioxide (TiO₂), yttrium oxide (Y₂O₃), magnesium oxide (MgO), calcium oxide (CaO) and rare earth metal oxides.

Furthermore, the binder phase may additionally also contain borates, for example aluminum borates or calcium borates. In addition, the binder phase may also contain impurities, for example carbon, metal impurities, elemental boron, boride, boron carbide or other carbides such as, for example, silicon carbide.

The proportion of nitrides and oxynitrides in the binder phase is preferably at least 50% by weight, particularly preferably at least 80% by weight, based on the total binder phase.

The binder phase preferably contains aluminum nitride, silicon nitride or titanium nitride or mixtures thereof in a proportion of ≧50% by weight, based on the total binder phase. The binder phase particularly preferably contains aluminum nitride, preferably in a proportion of ≧90% by weight, based on the total binder phase.

Metal powders are preferably used as binder phase raw materials for producing the nitride binder phase of the anisotropic nitride-bonded boron nitride agglomerates, which metal powders are converted, by direct nitridation, into the corresponding metal nitride or an oxynitride or mixtures of metal nitrides and oxynitrides. The metal powders that are used are preferably aluminum, silicon or titanium powders or mixtures thereof. Aluminum powder is used with particular preference. In the nitriding step, the metal is converted into the corresponding metal nitride. It is also possible that oxynitrides or mixtures of metal nitrides and oxynitrides form during nitridation.

Metal compounds in combination with reducing agents may also be used as binder phase raw materials for producing the nitride binder phase of the anisotropic nitride-bonded boron nitride agglomerates, the nitride binder phase being produced via reduction-nitridation. The metal compounds used are preferably compounds from the elements aluminum, silicon and titanium, preferably oxides and/or hydroxides such as, for example, aluminum oxide (Al₂O₃), aluminum hydroxide (Al(OH)₃), boehmite (AlOOH), silicon dioxide (SiO₂) and titanium dioxide (TiO₂). The metal compounds used may also be borates, for example aluminum borate. Carbon and hydrogen as well as organic compounds such as, for example, polyvinyl butyral (PVB), melamine and methane may be used as reducing agents. If gaseous substances such as, for example, hydrogen or methane are used as reducing agents, these substances are added to the nitriding atmosphere. The reducing agent necessary for the reduction may also already exist in the metal compound, thus making the use of additional reducing agents unnecessary, for example when using aluminum isopropoxide, tetraethylorthosilicate or titanium isopropoxide as binder raw materials. In the nitriding step, the metal compounds are converted into the corresponding metal nitrides. It is also possible that oxynitrides or mixtures of metal nitrides and oxynitrides form during nitridation; likewise, the binder phase may still contain residual unreacted oxides.

Reactants for producing boron nitride may also be used as binder phase raw materials for producing the nitride binder phase of the anisotropic nitride-bonded boron nitride agglomerates. The reactants for producing boron nitride may contain an oxidic boron source such as, for example, boric acid (H₃BO₃) and boron oxide (B₂O₃) in combination with a reducing agent such as, for example, carbon or hydrogen or organic compounds such as polyvinyl alcohol (PVA), polyvinyl butyral (PVB), melamine and methane. If gaseous substances such as, for example, hydrogen or methane are used as reducing agents, these substances are added to the nitriding atmosphere. Substantially oxygen-free boron sources such as, for example, elemental boron, boron carbide and trimethyl borate may also be used as reactants for producing boron nitride. In the nitriding step, these raw materials are converted to hexagonal boron nitride.

The binder phase raw materials used for producing the nitride binder phase of the anisotropic nitride-bonded boron nitride agglomerates may also be nitride materials which solidify during the heat treatment in the nitriding atmosphere. The nitride material may be a nitride and/or oxynitride compound of aluminum or silicon, but titanium nitride and rare earth nitrides may also be used; likewise, compounds from the group consisting of sialons. Liquid phases such as, for example, yttrium oxide, aluminum oxide, magnesium oxide, calcium oxide, silicon oxide and rare earth oxides may be used as sintering aids.

It is also possible to use mixtures of the different binder phase raw materials listed.

Hexagonal boron nitride, amorphous boron nitride, partially crystalline boron nitride and mixtures thereof may be used as the boron nitride feedstock powder for producing the anisotropic scale-like boron nitride agglomerates.

The average particle size d₅₀ of the boron nitride powder that is used may be 0.5-50 μm, preferably 0.5-15 μm, more preferably 0.5-5 μm. For instance, hexagonal boron nitride powders having an average particle size of 1 μm, 3 μm, 6 μm, 9 μm and 15 μm may be used, but greater average particle sizes of up to 50 μm are also possible. Mixtures of different hexagonal boron nitride powders having different particle sizes may likewise be used.

Measuring the average particle size (d₅₀) of the boron nitride powders that are used is typically carried out by means of laser diffraction (wet measurement, Mastersizer 2000, Malvern).

B₂O₃-free boron nitride powders and boron nitride powders with lower B₂O₃ contents of up to 0.5% by weight, but also with higher B₂O₃ contents of up to 10% by weight and more, may be used. It is also possible to use mixtures of powdered or granulated boron nitride. The binder phase raw materials may be present in solid or liquid or paste-like form.

Mixing boron nitride feedstock powder and binder phase raw materials may be carried out in a mixing drum, in a V-mixer, a drum hoop mixer, a vibrating tube mill or an Eirich mixer, for example. Homogeneity may be further increased in a subsequent milling step (e.g. cross beater mill, tumbling mill, agitator bead mill). The powder mixture may be dry or moistened. It is likewise possible to add pressing aids and, if necessary, lubricating aids. Mixing may also be carried out wet, for example, if the subsequent production of the granules is carried out via spray-drying or build-up granulation.

The material compacted into scale-like agglomerates is subsequently subjected to high-temperature annealing in a nitriding atmosphere at temperatures of at least 1600° C., preferably at least 1800° C. The nitriding atmosphere preferably comprises nitrogen and/or ammonia. The nitriding atmosphere preferably additionally contains argon. After achieving the maximum temperature, a holding time of up to several hours or days can be initiated. The heat treatment may be carried out in a continuous or batch method.

Due to the heat treatment in the nitriding atmosphere, a nitride binder phase forms as a secondary phase which bonds the primary boron nitride particles to one another. Due to the nitriding step, the degree of crystallization of the primary particles may increase, which is accompanied by primary particle growth.

The remainder of raw materials unreacted during nitridation in the binder phase in the anisotropic nitride-bonded boron nitride mixed agglomerates is preferably ≦10%, more preferably ≦5%, even more preferably ≦3% and particularly preferably ≦2%. The contamination with oxygen is preferably ≦10%, more preferably ≦5%, even more preferably ≦2% and particularly preferably ≦1%.

Prior to the high-temperature treatment, the material compacted into scale-like agglomerates is preferably subjected to a further heat treatment at a temperature of at least 700° C. in a nitriding atmosphere, wherein the temperature of this first heat treatment is below the temperature of the high-temperature treatment. The nitriding atmosphere of this initial nitridation preferably comprises nitrogen and/or ammonia. The nitriding atmosphere preferably additionally contains argon.

With rising temperature and duration of the heat treatment, the degree of crystallization increases in the primary boron nitride particles contained in the scale-like boron nitride mixed agglomerates, and the oxygen content and specific surface area of the primary boron nitride particles that are present decreases.

To achieve the target agglomerate size of the scale-like boron nitride agglomerates, customary steps such as screening, screen fractioning and sifting may be taken. If fines are contained, they may be removed first. As an alternative to screening, the defined comminution of the agglomerates may also be carried out with sieve graters, classifier mills, structured roller crushers or cutting wheels. Grinding, for instance in a ball mill, is also possible. The agglomerates of several millimeters to several centimeters in size are processed in a further process step into defined agglomerate sizes. To this end, standard commercial screens having different mesh widths and sieving aids on a vibrating screen may be used, for example. A multi-step sieving/comminution sieving process has proven to be advantageous.

Following their production, the anisotropic scale-like boron nitride agglomerates may be subjected to further treatments. In this case, for example, one or more of the following possible treatments may be carried out:
a steam treatment
a surface modification with silanes, titanates or other organometallic compounds, either at room temperature or under the effect of heat and with carrier or reaction gases. This surface modification also increases the hydrolysis resistance of the nitride binder phase in the case of the nitride-bonded scale-like agglomerates.
a surface modification with polymers, for example with polyethylene glycol (PEG), polyvinyl alcohol (PVA), polyvinyl butyral (PVB), polyvinyl pyrrolidone (PVP), copolymers, acrylates, oils or carboxylic acids.
an infiltration with sol-gel systems, for example with boehmite sol or SiO₂ sol, or with water-soluble glasses or nanoparticles or surface-modified nanoparticles or mixtures thereof.
an infiltration with water-soluble or ethanol-soluble polymers. The boron nitride agglomerates may be infiltrated with resins such as, for example, silicone, epoxy or polyurethane resins, and the resin may be hardened with hardener or be heat-hardened before or during compounding.
in the case of nitride-bonded scale-like agglomerates, a heat treatment under oxygen, which leads to a surface oxidation of the anisotropic nitride-bonded boron nitride agglomerates. For instance, agglomerates with surface TiO₂ can be produced with a binder phase containing titanium nitride (TiN) by oxidation in air above at 500° C.; surface SiO₂ can be produced with a binder phase containing silicon nitride (Si₃N₄), and surface aluminum oxide (Al₂O₃) can be produced with a binder phase containing aluminum nitride (AlN). For anisotropic nitride-bonded boron nitride agglomerates containing AlN as the binder phase, a heat treatment in air can be carried out, preferably at temperatures of 500° C. and higher, more preferably at temperatures between 700° C. and 1200° C. and particularly preferably at temperatures between 700° C. and 1000° C.

The listed surface treatments may also be carried out for mixtures of anisotropic nitride-bonded boron nitride agglomerates with other boron nitride fillers such as, for example, primary boron nitride particles.

It is also possible to combine several of the listed treatments in any order. For example, the treatments may be carried out in a fluidized bed method.

With the listed treatments, it is possible to achieve an improved coupling of the polymer matrix to the scale-like boron nitride agglomerates in the polymer/boron nitride compound according to the invention.

The anisotropic nitride-bonded boron nitride agglomerates exhibit excellent mechanical stability. The mechanical stability of the boron nitride agglomerates is important since it must withstand (if possible with only minimal disintegration) filling, transporting, dosing, compounding, that is, further processing of the boron nitride agglomerates into polymer/boron nitride compounds, and subsequent molding by injection molding. Should the boron nitride agglomerates disintegrate during compounding, the danger exists that the rheological properties of the polymer/boron nitride compounds worsen and thermal conductivity decreases in the through-plane direction in the component parts produced from the compounds, in particular in injection-molded thin plates. There is a risk that the boron nitride agglomerates degrade to the point that thermal conductivity in the through-plane direction is lowered so far that it sinks to a level comparable to that of polymer compounds produced with the use of primary boron nitride particles.

With the anisotropic scale-like boron nitride agglomerates and the anisotropic nitride-bonded boron nitride agglomerates, thermal conductivity in the polymer/boron nitride compounds according to the invention is not as directionally dependent as in polymer/boron nitride compounds produced with the use of platelet-shaped primary boron nitride particles. The through-plane thermal conductivity of the boron nitride polymer compounds according to the invention produced with the anisotropic scale-like boron nitride agglomerates and isotropic nitride-bonded boron nitride agglomerates is approximately on the same level, whereas the in-plane thermal conductivity of the polymer/boron nitride compound according to the invention produced with the anisotropic scale-like boron nitride agglomerates and anisotropic nitride-bonded boron nitride agglomerates is significantly higher than the polymer/boron nitride compounds according to the invention produced using isotropic nitride-bonded boron nitride agglomerates with an identical chemical composition. The anisotropic scale-like boron nitride agglomerates and the anisotropic nitride-bonded boron nitride agglomerates have sufficient strength to withstand the compounding process with a polymer melt in high numbers and large sizes.

Surprisingly, through-plane thermal conductivity of anisotropic nitride-bonded boron nitride agglomerates can be increased in the polymer/boron nitride compound by 50% and more with a filler loading of 30% by volume, and more than two-fold with a filler loading of 40% by volume under otherwise comparable processing conditions, compared with the use of non-agglomerated platelet-shaped boron nitride. It is particularly surprising that these increases were also achieved with rough compounding in a twin-screw extruder and when injection molding thin plates.

The isotropic nitride-bonded boron nitride agglomerates, anisotropic scale-like boron nitride agglomerates and the scale-like boron nitride agglomerates with inorganic binder phase are stable enough to be used in the compounding and injection molding of thin plates having a wall thickness of about 2 mm. If the wall thickness of thin plates, in which an even higher stability of the agglomerates is necessary, is further reduced, an adjustment to the stability requirements can take place in each case by increasing the proportion of the binder phase in the isotropic nitride-bonded boron nitride agglomerates and the scale-like boron nitride agglomerates with inorganic binder phase.

It is also advantageous that, by adjusting or increasing the stability of isotropic nitride-bonded boron nitride agglomerates and the scale-like boron nitride agglomerates with inorganic binder phase, mixtures with abrasive secondary fillers are also possible. In mixtures of boron nitride agglomerates with abrasive secondary fillers, customary boron nitride agglomerates are degraded. In the boron nitride agglomerates that are used according to the invention, degradation is reduced to the degree that the advantageous thermal conductivity properties, such as for example the anisotropy ratio, are maintained.

It is furthermore of advantage that the stability of the isotropic nitride-bonded boron nitride agglomerates and the scale-like boron nitride agglomerates with inorganic binder phase can be adjusted by increasing the proportion of binder phase, in particular in the case of high filler contents, in which melt viscosity during thermoplastic processing is high and where thus high shear of the filler takes place, and that processing of high filler contents or high contents of filler mixtures are therefore possible.

Owing to the adjustability of the stability of the isotropic nitride-bonded boron nitride agglomerates, the anisotropic scale-like boron nitride agglomerates and scale-like boron nitride agglomerates with an inorganic binder phase, a good compromise can be reached between the abrasivity of the thermally conductive filler and adequate stability for each application.

In a further preferred embodiment, the component part and polymer/boron nitride compound according to the invention may additionally also contain at least one filler as a thermally conducting filler which is different from boron nitride and which increases thermal conductivity, in addition to boron nitride agglomerates as thermally conducting filler. These additional fillers are also referred to hereinafter as secondary fillers.

The thermal conductivity of such secondary fillers is typically ≧5 W/m*K, preferably ≧8 W/m*K.

The total proportion of boron nitride agglomerates and secondary fillers in the component part and polymer/boron nitride compound according to the invention is preferably at least 20% by volume, and more preferably at least 30% by volume, based on the total volume of the polymer/boron nitride compound in each case. Preferably, the total proportion of boron nitride agglomerates and secondary fillers in the component part and polymer/boron nitride compound according to the invention is at most 70% by volume, more preferably at most 60% by volume, based on the total volume of the polymer/boron nitride compound in each case. Particularly preferably, the total proportion of boron nitride agglomerates and secondary fillers in the component part and polymer/boron nitride compound according to the invention is at most 50% by volume based on the total volume of the polymer/boron nitride compound in each case.

Powdered metal, preferably selected from the group comprising aluminum, silicon, titanium, copper, iron and bronze powder and mixtures thereof may be used as secondary fillers.

Carbon in the form of graphite, expanded graphite or carbon black may also be used as secondary filler, expanded graphite being particularly preferred.

Furthermore, ceramic fillers such as oxides, nitrides and carbides may also be used as secondary fillers, preferably selected from the group comprising aluminum oxide, magnesium oxide, aluminum nitride, silicon dioxide, silicon carbide, silicon nitride and mixtures thereof, particularly preferably aluminum oxide, magnesium oxide and/or aluminum nitride.

Mineral fillers can also be used as secondary fillers preferably selected from the group comprising aluminosilicates, aluminum silicates, magnesium silicate (2MgO*SiO₂), magnesium aluminate (MgO*Al₂O₃), brucite (magnesium hydroxide, Mg(OH)₂), Quartz, cristobalite and mixtures thereof. Kyanite (Al₂SiO₅) and/or mullite (3Al₂O₃*2SiO₂) may be used, for example, as aluminosilicates or aluminum silicates.

Combinations of secondary fillers are also possible. A combination of anisotropic nitride-bonded boron nitride agglomerates, aluminosilicate and expanded graphite as thermally conducting fillers has proven particularly advantageous in the component part and polymer/boron nitride compound according to the invention.

It is preferred that the secondary fillers are present in particulate form. The shape of the secondary filler particles may be irregular, chunky or spherical, or platelet-shaped. The proportion of platelet-shaped secondary fillers in the component part and polymer/boron nitride compound according to the invention is preferably not more than 10% by volume, more preferably not more than 5% by volume.

The secondary fillers preferably have a particle diameter or platelet diameter of ≧0.5 μm, more preferably of ≧1 μm, more preferably of ≧2 μm, and particularly preferably of ≧5 μm.

The secondary filler is present as a powder, preferably an agglomerated powder. The agglomeration of the secondary filler may be carried out via roller compaction or build-up granulation, for example in an Eirich mixer. A PVA solution may be used as the granulating agent. During compounding, the secondary filler granules are preferably mixed with the boron nitride filler in the extruder prior to dosing. The secondary filler granules are dried prior to mixing the secondary filler granules with the boron nitride filler. Granulating the secondary filler facilitates uniform dosing during compounding.

When using filler combinations of boron nitride agglomerates and secondary fillers, the isotropic nitride-bonded boron nitride agglomerates and/or the anisotropic scale-like boron nitride agglomerates are preferably used in combination with secondary fillers. Preference is given to the use of a filler mixture consisting of the anisotropic scale-like boron nitride agglomerates and secondary fillers.

The thermal conductivity of the component parts and polymer/boron nitride compounds according to the invention with filler combinations of scale-like boron nitride agglomerates and secondary fillers is higher than that of polymer compounds produced with the use of secondary fillers alone, in each case using the same proportion of fillers in the total volume.

Surprisingly, the combination of boron nitride agglomerates, in particular the preferred anisotropic scale-like boron nitride agglomerates, with secondary fillers, shows that the achieved thermal conductivity values of the polymer/boron nitride compound according to the invention that are produced with the filler combinations are higher than would have bee expected if the thermal conductivity values for the polymer materials that are individually filled with the corresponding proportions of boron nitride agglomerates and secondary fillers (in each case minus the thermal conductivity of the unfilled base polymer) had been added. This applies both to in-plane thermal conductivity and through-plane thermal conductivity.

In addition to the boron nitride agglomerates, the component parts and polymer/boron nitride compound according to the invention can also contain primary boron nitride particles. Likewise, primary boron nitride particles may additionally be used in the polymer/boron nitride compounds produced using filler combinations of boron nitride agglomerates and secondary fillers. The primary boron nitride particles used may be boron nitride powders, but also less stable boron nitride agglomerates such as, for example, spray-dried boron nitride agglomerates, which are largely or completely degraded to primary particles during compounding. The proportion of additional primary boron nitride particles in the polymer/boron nitride compound according to the invention is preferably ≦20% by volume, particularly preferably ≦10% by volume.

In addition to the boron nitride agglomerates or the boron nitride agglomerates and secondary fillers having a thermal conductivity of ≧5 W/m*K, the component parts and polymer/boron nitride compounds according to the invention may also contain additional fillers different from boron nitride having a lower thermal conductivity of ≦5 W/m*K such as, for example, talc.

In addition to the thermally conductive fillers, the component parts and polymer/boron nitride compounds according to the invention may also contain additional additives and fillers which assume other functions such as, for example, adjusting the mechanical or electrical properties or the thermal expansion coefficient. The fillers may be present, for instance, as chunky, spherical, platelet-shaped, fibrous particles, or as particles having an irregular morphology.

For producing the component parts and polymer/boron nitride compounds according to the invention, mixtures of different fractions of nitride-bonded isotropic boron nitride agglomerates or anisotropic scale-like boron nitride agglomerates may also be used. Mixtures of nitride-bonded isotropic boron nitride agglomerates and anisotropic scale-like boron nitride agglomerates are also possible.

The polymer/boron nitride compounds according to the invention can be produced by compounding, using any of the common compounding aggregates. This includes, inter alia, single-screw extruders, twin-screw extruders, tangential or closely intermeshing co- or counter-rotating planetary roller extruders, grooved barrel extruders, pin-type extruders, calendaring, Buss co-kneaders, shearing roller extruders and injection molding machines and reactors. Compounding in a twin-screw extruder is preferred.

The polymer that is used for compounding may be present in powder form or in the form of granules. The polymer may be premixed in dry form with the boron nitride agglomerates or with the boron nitride agglomerates and further fillers before the mixture is supplied to a compounding aggregate. Alternatively, the addition of the boron nitride agglomerates and optionally further fillers to the polymer melt may be carried out via side feeders without first premixing the filler with the polymer. Furthermore, a master batch, that is, a polymer compound with a filler content that is higher than in the final application, can first be produced and then homogenized with the polymer, for example in a twin-screw extruder.

After homogenizing in the compounding aggregate, the filled polymer melt is granulated. The granulation of the polymer/boron nitride compound can for example be granulated by strand pelletizing, underwater granulation, hot cut or cold cut pelletizing. A combination of the methods for processing the compound is also possible. The obtained polymer/boron nitride compound in granular form can be further processed via shaping methods such as, for example, injection molding to form component parts.

The component parts according to the invention are produced by thermoplastically processing the polymer/boron nitride compounds. The polymer/boron nitride compounds can be shaped into any desired shape, for example by injection molding, extruding, calendaring or injection stamping, preferably by injection molding or extruding. Processing by injection molding is particularly preferred. To this end, for example, the compound granules or compound granule mixture from master batches can be melted in a hydraulically or electromechanically driven plasticization unit and, if necessary, may also be homogenized with additional fillers or polymers until it leaves the nozzle. During the subsequent injection phase, the melt may be injected into the closed mold of an injection molding machine. In doing so, both classic injection molds and molds having hot runner systems may be used. After the cavity is completely filled, the holding pressure can be held constant until the component part is completely solidified. After the cooling time has elapsed, the mold can be opened and the component part can be ejected. Ejection, in turn, may be carried out by the ejecting unit of the injection molding machine or by other ways of removal, such as robotic arms.

During thermoplastic processing, that is, during the production of the polymer/boron nitride compound according to the invention or during injection molding of the component part according to the invention, a proportion of the nitride-bonded isotropic boron nitride agglomerates can degrade from shearing during compounding or during injection molding, into primary particles or agglomerate fragments without the advantageous properties of the compound being lost.

The component parts according to the invention are used for heat dissipation of component parts or assemblies to be cooled, preferably electronic component parts or assemblies.

The component parts according to the invention contain thin-walled parts, through which heat of component parts or assemblies to be cooled can be dissipated. The thin-walled parts of the component part have a thickness of ≦3 mm, preferably ≦2 mm. The component part according to the invention may be present, for example, as a thin plate having a thickness of ≦3 mm, preferably ≦2 mm, which can be produced, for example, by means of injection molding or extrusion as the shaping method. The component parts according to the invention may also be electrically conductive or electrically insulating. During shaping or in a subsequent processing step, it is also possible to produce a laminate consisting of conductive and non-conductive layers in the form of a thin plate, wherein at least the electrically insulating layer of the thin plate was produced using the polymer/boron nitride compound according to the invention.

After shaping, for example by means of injection molding, the component part according to the invention may also be provided with a coating; it may, for example, be metallized. It is also possible to apply conductor paths.

The component part according to the invention may be present as a flat or curved plate having a uniform or non-uniform wall thickness. The surface of the component part according to the invention may be smooth or textured.

The component part according to the invention may serve as a carrier plate for electronic component parts or transfer heat from one component part to another. The component part according to the invention may also be present as a film or as a thin-walled tube. The component part according to the invention may also be present as a thin-walled essential part of a substantially thin-walled housing, a mounting or a connecting element or a tube. The component part according to the invention may furthermore be present as a cooling fin as part of a cooling element, a housing, a mounting, a connecting element or a tube, wherein the mounting may be a lamp socket, for example. In more complex component parts, the component part according to the invention may, as a plate, be part of a stack of plates, wherein the plate in the stack of plates may serve as a cooling fin.

The following points are intended to explain the invention and preferred embodiments.

1. A component part having a wall thickness of at most 3 mm on at least one part of the component part, wherein the component part is produced by thermoplastic processing of a polymer/boron nitride compound, and wherein the polymer/boron nitride compound comprises a thermoplastically processable polymer material and a thermally conducting filler, and wherein the filler comprises boron nitride agglomerates.
2. The component part according to point 1, wherein the through-plane thermal conductivity of the component part is at least 1 W/m*K, preferably at least 1.2 W/m*K, more preferably at least 1.5 W/m*K, and particularly preferably at least 1.8 W/m*K, wherein the thermal conductivity i s measured according to DIN EN ISO 22007-4 on disk-shaped, injection-molded samples having a thickness of 2 mm.
3. The component part according to point 1 or 2, wherein the in-plane thermal conductivity of the component part is at least 1.5 W/m*K, preferably at least 1.8 W/m*K, more preferably at least 2.2 W/m*K, and particularly preferably at least 2.7 W/m*K, wherein the thermal conductivity is measured according to DIN EN ISO 22007-4 on disk-shaped, injection-molded samples having a thickness of 2 mm.
4. The component part according to point 2 and/or 3, wherein the anisotropy ratio of the in-plane thermal conductivity to the through-plane thermal conductivity is at least 1.5 and at most 4, preferably at least 1.5 and at most 3.5, even more preferably at least 1.5 and at most 3.0, and particularly preferably at least 1.5 and at most 2.5.
5. The component part according to any of points 1 to 4, wherein the through-plane thermal conductivity of the component part is at least 0.8 W/m*K, preferably at least 1 W/m*K, more preferably at least 1.3 W/m*K, and particularly preferably at least 1.6 W/m*K higher than the thermal conductivity of the polymer material without thermally conductive filler, wherein the thermal conductivity is measured according to DIN EN ISO 22007-4 on disk-shaped, injection-molded samples having a thickness of 2 mm in the through-plane direction.
6. The component part according to any of points 1 to 5, wherein the in-plane thermal conductivity of the component part is at least 1.3 W/m*K, preferably at least 1.6 W/m*K, more preferably at least 2.0 W/m*K, and particularly preferably at least 2.5 W/m*K higher than the thermal conductivity of the polymer material without thermally conductive filler, wherein the thermal conductivity is measured according to DIN EN ISO 22007-4 on disk-shaped, injection-molded samples having a thickness of 2 mm in the in-plane direction.
7. The component part according to any of points 1 to 6, wherein the proportion of boron nitride agglomerates is at least 5% by volume, preferably at least 10% by volume, more preferably at least 20% by volume, and particularly preferably at least 30% by volume, based on the total volume of the polymer/boron nitride compound.
8. The component part according to any of points 1 to 7, wherein the proportion of boron nitride agglomerates is at most 70% by volume, preferably at most 60% by volume, and particularly preferably at most 50% by volume, based on the total volume of the polymer/boron nitride compound.
9. The component part according to any of points 1 to 8, wherein the polymer material is selected from the group consisting of the thermoplastic materials polyamide (PA), polyphenylene sulfide (PPS), polycarbonate (PC), polypropylene (PP), thermoplastic elastomers (TPE), thermoplastic polyurethane elastomers (TPU), polyether ether ketones (PEEK), liquid crystal polymers (LCP), polyoxymethylene (POM), and duroplastic molding materials which can be thermoplastically processed.
10. The component part according to any of points 1 to 9, wherein the boron nitride agglomerates comprise platelet-shaped hexagonal boron nitride primary particles, which are connected to one another by means of an inorganic binder phase, which comprises at least one nitride and/or oxynitride.
11. The component part according to point 10, wherein the inorganic binder phase of the boron nitride agglomerates comprises aluminum nitride (AlN), aluminum oxynitride, titanium nitride (TiN), silicon nitride (Si₃N₄), or/and boron nitride (BN), preferably aluminum nitride, aluminum oxynitride, titanium nitride, and/or silicon nitride, more preferably aluminum nitride and/or aluminum oxynitride.
12. The component part according to point 10 or 11, wherein the inorganic binder phase of the boron nitride agglomerates comprises aluminum nitride.
13. The component part according to any of points 10 to 12, wherein the boron nitride agglomerates have a binder phase proportion of at least 1% by weight, preferably at least 5% by weight, more preferably at least 10% by weight, more preferably at least 20% by weight, and particularly preferably at least 30% by weight, based on the total quantity of boron nitride agglomerates in each case.
14. The component part according to any of points 10 to 13, wherein the average agglomerate diameter (d₅₀) of the boron nitride agglomerates is ≦1000 μm, preferably ≦500 μm, more preferably ≦400 μm, more preferably ≦300 μm, and particularly preferably ≦200 μm.
15. The component part according to any of points 10 to 14, wherein the aspect ratio of the boron nitride agglomerates is from 1.0 to 1.8, preferably from 1.0 to 1.5.
16. The component part according to any of points 1 to 15, wherein the boron nitride agglomerates comprise platelet-shaped hexagonal primary boron nitride particles, which are agglomerated with one another to form flake-like boron nitride agglomerates.
17. The component part according to point 16, wherein the texture index of the scale-like boron nitride agglomerates is greater than 2.0, and preferably 2.5 and more, or more preferably 3.0 and more, or particularly preferably 3.5 and more.
18. The component part according to either point 16 or 17, wherein the average agglomerate diameter (d₅₀) of the scale-like boron nitride agglomerates is ≦1000 μm, preferably ≦500 μm, more preferably ≦400 μm, more preferably ≦300 μm, and particularly preferably ≦200 μm.
19. The component part according to any of points 16 to 18, wherein the thickness of the scale-like boron nitride agglomerates is ≦500 μm, preferably ≦200 μm, more preferably ≦100 μm, more preferably ≦70 μm, more preferably ≦50 μm, and particularly preferably ≦35 μm.
20. The component part according to any of points 16 to 19, wherein the aspect ratio of the scale-like boron nitride agglomerates is greater than 1, and preferably 2.0 and more, more preferably 3.0 and more, more preferably 5 and more, and particularly preferably 10 and more.
21. The component part according to any of points 16 to 20, wherein the scale-like boron nitride agglomerates comprise an inorganic binder phase.
22. The component part according to point 21, wherein the scale-like boron nitride agglomerates have a binder phase proportion of at least 1%, preferably of at least 5%, more preferably of at least 10%, more preferably of at least 20%, and particularly preferably of at least 30%, based on the total quantity of the scale-like boron nitride agglomerates in each case.
23. The component part according to either point 21 or 22, wherein the binder phase comprises aluminum nitride (AlN), aluminum oxynitride, titanium nitride (TiN), silicon nitride (Si₃N₄), or/and boron nitride (BN), preferably aluminum nitride, aluminum oxynitride, titanium nitride, and/or silicon nitride, more preferably aluminum nitride and/or aluminum oxynitride.
24. The component part according to point 23, wherein the binder phase contains aluminum nitride (AlN).
25. The component part according to any of points 1 to 24, comprising at least one filler different from boron nitride which increases thermal conductivity.
26. The component part according to point 25, wherein the filler different from boron nitride is a metal powder, preferably selected from the group comprising aluminum, silicon, titanium, copper, iron, and bronze powder, and mixtures thereof.
27. The component part according to point 25, wherein the filler different from boron nitride is carbon in the form of graphite, expanded graphite, or carbon black, wherein expanded graphite is particularly preferred.
28. The component part according to point 25, wherein the filler different from boron nitride is an oxide, nitride, or carbide, preferably selected from the group comprising aluminum oxide, magnesium oxide, aluminum nitride, silicon dioxide, silicon carbide, silicon nitride, and mixtures thereof, with aluminum oxide, magnesium oxide, and/or aluminum nitride being particularly preferred.
29. The component part according to point 25, wherein the filler different from boron nitride is a mineral filler and is preferably selected from the group comprising aluminosilicates, aluminum silicates, magnesium silicate (2MgO*SiO₂), magnesium aluminate (MgO*Al₂O₃), brucite (magnesium hydroxide, Mg(OH)₂), quartz, cristobalite, and mixtures thereof.
30. The component part according to any of points 25 to 29, wherein the total proportion of boron nitride agglomerates and the thermally conductive fillers different from boron nitride is at least 20% by volume, preferably at least 30% by volume, based on the total volume of the polymer/boron nitride compound in each case.
31. The component part according to any of points 25 to 30, wherein the total proportion of boron nitride agglomerates and the thermally conductive fillers different from boron nitride is at most 70% by volume, preferably at most 60% by volume, and particularly preferably at most 50% by volume, based on the total volume of the polymer/boron nitride compound in each case.
32. The component part according to any of points 1 to 31, wherein the wall thickness of the component part is at most 2 mm on at least one part of the component part.
33. The polymer/boron nitride compound for producing a component part according to any of points 1 to 32, wherein the polymer/boron nitride compound comprises a thermoplastically processable polymer material and a thermally conducting filler, wherein the filler comprises boron nitride agglomerates.
34. The use of a component part according to any of points 1 to 32 for heat dissipation from component parts or assemblies to be cooled, preferably from electronic component parts or assemblies.

### EXAMPLES AND REFERENCE EXAMPLES

For compounding the polymers with the boron nitride agglomerates or filler mixtures, a ZSE 18 MAXX twin-screw extruder (Leistritz, Nuremburg, Germany) is used. Two different screw configurations are used, one of which is the comparatively rough, “standard,” screw configuration with two mixing elements and six kneading blocks (screw configuration 1), the other one is the gentler, “soft,” screw configuration with three mixing elements and no kneading blocks (screw configuration 2). The screw speeds are set to 300 RPM and 900 RPM. Polyamide PA 6 (Schulamid® 6 NV 12) is used as the polymer. During compounding, the polymer melt is heated to 265° C. The throughput is set to 6 kg/h in all tests. The polymer is supplied via the main feeder. The filler (boron nitride agglomerates) or the filler mixture (boron nitride agglomerates and secondary fillers) is supplied via a side feeder.

The filler-containing polymer melt is discharged through two 3 mm nozzles, cooled in the form of strands and processed in a shredder to form granules. Via injection molding, 2 mm thin plates having a base of 80×80 mm² are produced from the granules.

### Example 1

### Example 1a)

### Production of Boron Nitride Hybrid Flakes (Anisotropic Scale-Like Nitride-Bonded Boron Nitride Agglomerates)

4000 g aluminum paste STAPAALUPOR SK I-NE/70 (from Eckart, Hartenstein, Germany) and 7000 g boron nitride powder BORONID® S1-SF (ESK Ceramics GmbH & Co. KG, Germany; average particle size d₅₀=3 μm, measured by means of laser diffraction (Mastersizer 2000, Malvern, wet measurement)) are homogenized with grinding balls in a PE drum on a roller block for 20 hours. The powder mixture is dosed via gravimetric dosing with 8 kg/h in a roller compactor RC 250*250 (Powtec, Remscheid, Germany). The roller compacter is modified in such a way that the smooth stainless steel rollers make contact when they run empty. A contact force of 75 kN is exerted on the rollers, which corresponds to 3 kN/cm of the roller gap length, and the roller speed is set to 20 RPM. This results in boron nitride hybrid flakes having a thickness of 30 μm and a diameter of up to several centimeters. Green (i.e. compacted but not yet heat-treated) boron nitride hybrid flakes adhering to the rollers are removed by a scraper. After compaction, the fines <200 μm are removed by sieving and fed in during the next raw material homogenization with 4000 g aluminum paste and 7000 g boron nitride powder S1 in a PE drum. The process is repeated until a total of 55 kg boron nitride hybrid flakes have been produced. The boron nitride hybrid flakes are freed from binders under exclusion of air in an atmosphere of 80% nitrogen and 20% argon at 300° C., and the aluminum proportion in the boron nitride hybrid flakes is for the most part converted into MN at 800° C. in an atmosphere of 80% nitrogen and 20% argon during a holding time of 5 hours. High-temperature annealing is subsequently carried out at 1950° C. for 2 hours in an atmosphere of 80% nitrogen and 20% argon.

4000 g aluminum paste STAPAALUPOR SK. I-NE/70 (from Eckart, Hartenstein, Germany) and 7000 g boron nitride powder BORONID® S1-SF (ESK Ceramics GmbH & Co. KG Germany; average particle size d₅₀ 3 μm, measured by means of laser diffraction (Mastersizer 2000, Malvern, wet measurement)) are homogenized with grinding balls in a PE drum on a roller block for 20 hours. The powder mixture is dosed via gravimetric dosing with 8 kg/h in a roller compactor RC 250*250 (Powtec, Remscheid, Germany). The roller compacter is modified in such a way that the smooth stainless steel rollers make contact when they run empty. A contact force of 75 kN is exerted on the rollers, which corresponds to 3 kN/cm of the roller gap length, and the roller speed is set to 20 RPM, This results in boron nitride hybrid flakes having a thickness of 30 μm and a diameter of up to several centimeters. Green (i.e. compacted but not yet heat-treated) boron nitride hybrid flakes adhering to the rollers are removed by a scraper. After compaction, the fines <200 μm are removed by sieving and fed in during the next raw material homogenization with 4000 g aluminum paste and 7000 g boron nitride powder S1 in a PE drum. The process is repeated until a total of 55 kg boron nitride hybrid flakes have been produced. The boron nitride hybrid flakes are freed from binders under exclusion of air in an atmosphere of 80% nitrogen and 20% argon at 300° C., and the aluminum proportion in the boron nitride hybrid flakes is for the most part converted into AlN at 800° C. in an atmosphere of 80% nitrogen and 20% argon during a holding time of 5 hours. High-temperature annealing is subsequently carried out at 2050° C. for 2 hours in an atmosphere of 80% nitrogen and 20% argon.

The oxygen content was determined indirectly by means of carrier gas hot extraction, wherein the oxygen from the sample is reacted with carbon, and the content of developing CO₂ is determined by IR spectroscopy (TCH 600, LECO, Mönchengladbach, Germany). The oxygen content is 0.15%.

With X-ray radiography, it was possible to detect only the phases boron nitride and aluminum nitride.

The boron nitride hybrid flakes are broken up in a vibrating screen with rubber balls. Screens are used in the sequence of 5 mm, 2 mm, 1 mm, and 500 μm.

The obtained boron nitride hybrid flakes in the screen fraction <500 μm have an average particle size (d₅₀) of 192 μm, measured by means of laser diffraction (Mastersizer 2000, Malvern, wet measurement). The thickness of the boron nitride hybrid flakes is 30 μm. The thickness is determined using a digital precision gauge.

The texture index that is measured on a charge of boron nitride hybrid flakes is 20.6.

From the boron nitride hybrid flakes that are produced, a fraction <200 μm is broken up, and the fines <100 μm are separated by sieving. Agglomerate stability is determined on the screen fraction 100-200 μm of the boron nitride hybrid flakes thus obtained using the ultrasound method. Agglomerate stability that is determined on the boron nitride hybrid flakes is 75%.

The SEM overview image of the boron nitride hybrid flakes that are produced in the screen fraction <500 μm (FIG. 3a) clearly shows the flat surfaces of the agglomerates. These surfaces are shaped surfaces which were produced directly by the shaping method (compressing between two rotating, counter-moving rollers) and not by subsequent comminution. FIG. 4b shows a fractured surface of an agglomerate having a thickness of 30 μm, the flat shaped surface of said agglomerate and the flat shaped surface of an additional agglomerate.

### Example 1b

### Production of a Compound Consisting of PA 6 with 10% by Volume Boron Nitride Hybrid Flakes

In a twin-screw extruder (Leistritz ZSE 18 MAXX, Nuremburg, Germany), polyamide PA 6 (Schulamid® 6 NV 12, A. Schulman, Kerpen, Germany) is added as the polymer via a gravimetric main feeder and boron nitride hybrid flakes from example 1 a) via a gravimetric side feeder. The rough screw configuration 1 is used. The screw speed is set to 300 RPM and a throughput of 6 kg/h is run, wherein 4.8 kg/h PA 6 is dosed in the main feeding and 1.2 kg/h boron nitride hybrid flakes from the sieve fraction <500 μm in the side feeding. The obtained compound is channeled through two 3 mm nozzles, passes through a cooling section in a water bath and is shredded to form granules. The proportion of boron nitride hybrid flakes in the compound is 10% by volume.

### Example 1c

### Injection Molding of 2-Mm-Thin Plates and Measuring Thermal Conductivity

The compound granules from Example 1b) are injection molded into 2-mm-thin plates with the dimensions 80×80×2 mm³ in an injection-molding machine (Engel e-motion).

The thermal conductivity is measured at disc-shaped injection-molded samples having a thickness of 2 mm, and the sample for the measurement of the through-plane thermal conductivity is prepared with the dimensions 2×10×10 mm³ from the center of an injection-molded plate having a thickness of 2 mm (dimensions 2×80×80 mm³). The thickness of the sample for measuring thermal conductivity corresponds to the plate thickness from injection molding. The compound granules from example 1 b) are injection molded in an injection molding machine (Engel e-motion) into 2-mm-thin plates with the dimensions of 80×80×2 mm³.

Thermal conductivity is measured on disk-shaped injection-molded samples having a thickness of 2 mm, wherein the sample for measuring through-plane thermal conductivity is prepared from the center of an injection-molded plate having a thickness of 2 mm (dimensions 2×80×80 mm³) having the dimensions 2×10×10 mm³. The thickness of the sample for through-plane thermal conductivity measurement corresponds to the plate thickness from the injection molding. For measuring in-plane thermal conductivity, a stack of plates of injection-molded 2-mm-thin plates is glued together using instant glue, and a 2-mm-thin plate having the dimensions 2×10×10 mm³ is prepared from the stack of plates prepared in this manner parallel to the through-plane direction and perpendicular to the flow direction of the injection-molded samples. The in-plane thermal conductivity is determined using this sample.

The anisotropy ratio is calculated by taking the in-plane thermal conductivity determined as described and dividing it by the through-plane thermal conductivity measured as described.

For measuring thermal conductivity, the laser-flash method is used and carried out with a Nanoflash LFA 447 (Netzsch, Selb, Germany) according to DIN EN ISO 22007-4. Measurements are taken at 22° C.

Thermal conductivity (TC) is determined by measuring the values for thermal diffusivity a, specific thermal capacity cₚ and density D, and is calculated from these values according to the equation

TC=a*cₚ*D.

a and cₚ are measured with the Nanoflash LFA 447 (Netzsch, Selb, Germany) on the samples that are produced as described above, having the dimensions 10×10×2 mm³. Density is calculated by weighing and determining the geometrical dimensions of the precisely shaped samples. The standard Pyroceram 9606 is used for the measurement.

The compounding parameters, the results of the thermal conductivity measurements, and the anisotropy ratio are listed in table 1.

The thermal conductivity, which is determined on an injection-molded thin plate with the dimensions 80×80×2 mm³, for the unfilled polymer PA 6 (Schulamid® 6 NV 12) is 0.26 W/m*K.

### Example 2

### Production of a Compound Consisting of PA 6 with 20% by Volume Boron Nitride Hybrid Flakes

Production of the boron nitride hybrid flakes and compounding take place according to example 1, during which 20% by volume boron nitride hybrid flakes being compounded in PA 6 in this case, instead of 10% by volume boron nitride hybrid flakes.

Injection molding and the thermal conductivity measurements are performed as described in example 1. The compounding parameters, the results of the thermal conductivity measurements, and the anisotropy ratio are listed in table 1.

### Example 3

### Production of a Compound Consisting of PA 6 with 30% by Volume Boron Nitride Hybrid Flakes

Production of the boron nitride hybrid flakes and compounding is carried out according to example 1, during which 30% by volume boron nitride hybrid flakes is compounded in PA 6 in this case instead of 10% by volume boron nitride hybrid flakes.

Injection molding and the thermal conductivity measurements are performed as described in example 1. The compounding parameters, the results of the thermal conductivity measurements, and the anisotropy ratio are listed in table 1.

### Example 4

### Production of a Compound Consisting of PA 6 with 40% by Volume Boron Nitride Hybrid Flakes

Production of the boron nitride hybrid flakes and compounding is carried out according to example 1, during which 40% by volume boron nitride hybrid flakes being compounded in PA 6 in this case instead of 10% by volume boron nitride hybrid flakes.

Injection molding and the thermal conductivity measurements are performed as described in example 1. The compounding parameters, the results of the thermal conductivity measurements, and the anisotropy ratio are listed in Table 1.

### Example 5

### Production of a Compound Consisting of PA 6 with 50% by Volume Boron Nitride Hybrid Flakes

Production of the boron nitride hybrid flakes and compounding is carried out according to example 1, during which 50% by volume boron nitride hybrid flakes being compounded in PA 6 in this case instead of 10% by volume boron nitride hybrid flakes.

Injection molding and the thermal conductivity measurements are performed as described in example 1. The compounding parameters, the results of the thermal conductivity measurements, and the anisotropy ratio are listed in table 1.

### Example 6

### Production of a Compound Consisting of PA 6, 10% by Volume Boron Nitride Hybrid Flakes, and 10% by Volume Aluminosilicate

A filler mixture is produced by homogenizing 5.82 kg aluminosilicate Trefil 1360-400 (Quarzwerke, Frechen, Germany) having an average particle size (d₅₀) of 6.3 μm and 4.18 kg hybrid flakes from example 1 in a PE drum on a roller block for 5 minutes. The aluminosilicate has a density of 3.6 g/cm³, and the thermal conductivity is 14 W/m*K. According to the radiograph, the main phase of the aluminosilicate is kyanite (Al₂SiO₅). The filler mixture is adjusted such that the fillers are present at the same volumetric proportion, as calculated mathematically, in the filler mixture.

In a twin screw extruder (Leistritz ZSE18 max, Nuremburg, Germany), PA 6 (Schularnid® 6 NV 12, A. Schulman, Kerpen, Germany) is added in a gravimetric main feeding, and the filler mixture from the boron nitride hybrid flakes and aluminosilicate is added via a gravimetric side feeding. A screw speed of 300 RPM and a throughput rate of 6 kg/h are set on the twin screw extruder; 3.6 kg/h PA 6 is dosed in the main feeding and 2.4 kg/h filler mixture is dosed in a side feeding. Compounding is adjusted such that the volumetric proportion of the filler mixture in the compound is 20% by volume. The compound obtained is channeled through two 3-mm nozzles, then passes through a cooling section in the water bath, and is then shredded to form granules.

The proportion of boron nitride hybrid flakes in the compound is 10% by volume, and the proportion of aluminosilicate in the compound is also 10% by volume.

Injection molding and the thermal conductivity measurements are performed as described in example 1. The compounding parameters, the results of the thermal conductivity measurements, and the anisotropy ratio are listed in table 1.

### Example 7

### Production of a Compound Consisting of PA 6, 10% by Volume Boron Nitride Hybrid Flakes, and 20% by Volume Aluminosilicate

A filler mixture is produced as described in example 6, except that the quantity proportions of aluminosilicate and boron nitride hybrid flakes are selected such that the aluminosilicate in the filler mixture with the boron nitride hybrid flakes is present at double the volumetric proportion, when calculated mathematically. Compounding is performed as described in example 6, except that the volumetric proportion of the filler mixture in the compound is 30% by volume. The proportion of boron nitride hybrid flakes in the compound is 10% by volume, and the proportion of aluminosilicate in the compound is 20% by volume.

Injection molding and the thermal conductivity measurements are performed as described in example 1. The compounding parameters, the results of the thermal conductivity measurements, and the anisotropy ratio are listed in table 1.

### Example 8

### Production of a Compound Consisting of PA 6, 10% by Volume Boron Nitride Hybrid Flakes, and 30% by Volume Aluminosilicate

A filler mixture is produced as described in example 6, except that the quantity proportions of aluminosilicate and boron nitride hybrid flakes are selected such that the aluminosilicate in the filler mixture with the boron nitride hybrid flakes is present at triple the volumetric proportion, when calculated mathematically. Compounding is performed as described in example 6, except that the volumetric proportion of the filler mixture in the compound is 40% by volume. The proportion of boron nitride hybrid flakes in the compound is 10% by volume, and the proportion of aluminosilicate in the compound is 30% by volume.

Injection molding and the thermal conductivity measurements are performed as described in example 1. The compounding parameters, the results of the thermal conductivity measurements, and the anisotropy ratio are listed in table 1.

### Example 9

### Production of a Compound Consisting of PA 6, 10% by Volume Boron Nitride Hybrid Flakes, and 40% by Volume Aluminosilicate

A filler mixture is produced as described in example 6, except that the quantity proportions of aluminosilicate and boron nitride hybrid flakes are selected such that the aluminosilicate in the filler mixture with the boron nitride hybrid flakes is present at four times the volumetric proportion, when calculated mathematically. Compounding is performed as described in example 6, except that the volumetric proportion of the filler mixture in the compound is 50% by volume. The proportion of boron nitride hybrid flakes in the compound is 10% by volume, and the proportion of aluminosilicate in the compound is 30% by volume.

Injection molding and the thermal conductivity measurements are performed as described in example 1. The compounding parameters, the results of the thermal conductivity measurements, and the anisotropy ratio are listed in table 1.

### Example 10

### Production of a Compound Consisting of PA 6, 20% by Volume Boron Nitride Hybrid Flakes, and 10% by Volume Aluminosilicate

A filler mixture is produced as described in example 6, except that the quantity proportions of aluminosilicate and boron nitride hybrid flakes are selected such that the boron nitride hybrid flakes in the filler mixture with the aluminosilicate is present at double the volumetric proportion, when calculated mathematically. Compounding is performed as described in example 6, except that the volumetric proportion of the filler mixture in the compound is 30% by volume. The proportion of boron nitride hybrid flakes in the compound is 20% by volume, and the proportion of aluminosilicate in the compound is 10% by volume.

Injection molding and the thermal conductivity measurements are performed as described in example 1. The compounding parameters, the results of the thermal conductivity measurements, and the anisotropy ratio are listed in table 1.

### Example 11

### Production of a Compound Consisting of PA 6, 20% by Volume Boron Nitride Hybrid Flakes, and 20% by Volume Aluminosilicate

The filler mixture according to example 6 is produced. Compounding is performed as described in example 6, except that the volumetric proportion of the filler mixture in the compound is 40% by volume. The proportion of boron nitride hybrid flakes in the compound is 20% by volume, and the proportion of aluminosilicate in the compound is 20% by volume.

Injection molding and the thermal conductivity measurements are performed as described in example 1. The compounding parameters, the results of the thermal conductivity measurements, and the anisotropy ratio are listed in Table 1.

### Example 12

### Production of a Compound Consisting of PA 6, 20% by Volume Boron Nitride Hybrid Flakes, and 30% by Volume Aluminosilicate

A filler mixture is produced as described in example 6, except that the boron nitride hybrid flakes are present at 40% by volume in the filler mixture and the aluminosilicate is present at 60% by volume in the filler mixture, when calculated mathematically. Compounding is performed as described in example 6, except that the volumetric proportion of the filler mixture in the compound is 50% by volume. The proportion of boron nitride hybrid flakes in the compound is 20% by volume, and the proportion of aluminosilicate in the compound is 30% by volume.

Injection molding and the thermal conductivity measurements are performed as described in example 1. The compounding parameters, the results of the thermal conductivity measurements, and the anisotropy ratio are listed in table 1.

### Example 13

### Production of a Compound Consisting of PA 6, 30% by Volume Boron Nitride Hybrid Flakes and 10% by Volume Aluminosilicate

A filler mixture is produced as described in example 6, except that the boron nitride hybrid flakes are present at 75% by volume in the filler mixture and the aluminosilicate is present at 25% by volume in the filler mixture, when calculated mathematically. Compounding is performed as described in example 6, except that the volumetric proportion of the filler mixture in the compound is 40% by volume. The proportion of boron nitride hybrid flakes in the compound is 30% by volume, and the proportion of aluminosilicate in the compound is 10% by volume. Injection molding and the thermal conductivity measurements are performed as described in example 1. The compounding parameters, the results of the thermal conductivity measurements, and the anisotropy ratio are listed in table 1.

### Example 14

### Production of a Compound Consisting of PA 6, 30% by Volume Boron Nitride Hybrid Flakes, and 20% by Volume Aluminosilicate

A filler mixture is produced as described in example 6, except that the boron nitride hybrid flakes are present at 60% by volume in the filler mixture and the aluminosilicate is present at 40% by volume in the filler mixture, when calculated mathematically. Compounding is performed as described in example 6, except that the volumetric proportion of the filler mixture in the compound is 50% by volume. The proportion of boron nitride hybrid flakes in the compound is 30% by volume, and the proportion of aluminosilicate in the compound is 20% by volume.

Injection molding and the thermal conductivity measurements are performed as described in example 1. The compounding parameters, the results of the thermal conductivity measurements, and the anisotropy ratio are listed in table 1.

### Example 15

### Production of a Compound Consisting of PA 6, 40% by Volume Boron Nitride Hybrid Flakes, and 10% by Volume Aluminosilicate

A filler mixture is produced as described in example 6, except that the boron nitride hybrid flakes are present at 80% by volume in the filler mixture and the aluminosilicate is present at 20% by volume in the filler mixture, when calculated mathematically. Compounding is performed as described in example 6, except that the volumetric proportion of the filler mixture in the compound is 50% by volume. The proportion of boron nitride hybrid flakes in the compound is 40% by volume, and the proportion of aluminosilicate in the compound is 10% by volume.

Injection molding and the thermal conductivity measurements are performed as described in example 1. The compounding parameters, the results of the thermal conductivity measurements, and the anisotropy ratio are listed in table 1.

### Example 16

### Production of a Compound Consisting of PA 6, 20% by Volume Boron Nitride Hybrid Flakes, and 20% by Volume Magnesium Hydroxide

A filler mixture is produced as described in example 6, except that magnesium hydroxide (brucite, APYMAG 40, Nabaltech, Schwandorf, Germany) is used in this case in place of the aluminosilicate, and therefore the boron nitride hybrid flakes are present at 50% by volume in the filler mixture and the magnesium hydroxide is present at 50% by volume in the filler mixture, when calculated mathematically. The magnesium hydroxide has a density of 2.4 g/cm³. Compounding is performed as described in example 6, except that the volumetric proportion of the filler mixture in the compound is 40% by volume. The proportion of boron nitride hybrid flakes in the compound is 40% by volume, and the proportion of magnesium hydroxide in the compound is 10% by volume.

Injection molding and the thermal conductivity measurements are performed as described in example 1. The compounding parameters, the results of the thermal conductivity measurements, and the anisotropy ratio are listed in table 1.

### Example 17

### Production of a Compound Consisting of PA 6, 30% by Volume Boron Nitride Hybrid Flakes, and 10% by Volume Magnesium Hydroxide

A filler mixture comprising boron nitride hybrid flakes and magnesium hydroxide is produced as described in example 16, except that the boron nitride hybrid flakes are present at 75% by volume in the filler mixture and the magnesium hydroxide is present at 25% by volume in the filler mixture, when calculated mathematically. Compounding is performed as described in example 6, except that the volumetric proportion of the filler mixture in the compound is 40% by volume. The proportion of boron nitride hybrid flakes in the compound is 30% by volume, and the proportion of magnesium hydroxide in the compound is 10% by volume.

Injection molding and the thermal conductivity measurements are performed as described in example 1. The compounding parameters, the results of the thermal conductivity measurements, and the anisotropy ratio are listed in table 1.

### Example 18

### Production of Boron Nitride Hybrid Agglomerates (Isotropic Nitride-Bonded Boron Nitride Agglomerates) and Production of a Compound Consisting of PA 6 with 20% by Volume Boron Nitride Hybrid Agglomerates

14 kg hexagonal boron nitride powder (BORONID® S1-SF, ESK Ceramics GmbH & Co. KG, Germany, average particle size (d₅₀)=3 μm, measured by laser diffraction (Mastersizer 2000, Malvern, wet measurement)) is mixed with 8 kg aluminum powder from aluminum paste (Grade STAPA Alupor SK I-NE/75, from Eckart GmbH & Co. KG, Velden, Germany) and homogenized with grinding balls in a PE drum on a roller block for 20 hours.

The powder mixture is dispensed into an RC 250*250 roller compactor (Powtec, Remscheid, Germany) at 40 kg/h via gravimetric side feeding. The roller compactor is modified such that the corrugated stainless steel rollers make contact when they run empty. A contact force of 306 kN is exerted on to the rollers, which corresponds to 12.2 kN/cm of the roller gap length, and the roller speed is set to 25 RPM. Green scabs adhering to the rollers are removed using a scraper. The scabs have a thickness of 0.4-1.6 mm. The scabs are crushed in the integrated sieve grater with 1 mm mesh width. The resulting granules are fed back in under the same process conditions, during which, by bypassing the integrated sieve, scabs with a base surface of approximately 3 cm² and a thickness of from 0.4 to 1.6 mm are obtained.

After removal of binders in an atmosphere of nitrogen at 300° C. and initial nitridation in a nitrogen-argon mixture (80% nitrogen, 20% argon) at 800° C. for 5 hours, high-temperature nitridation and annealing of the binder phase are carried out at 1950° C. for 2 hours in a flowing nitrogen-argon atmosphere (80% nitrogen, 20% argon). In this process, heating is performed at 17.5° C./min up to 1600° C.; after one hour of hold time at 1600° C., further heating is performed at 17.5° C./ruin until the final temperature of 1950° C. is reached. The nitride-bonded boron nitride scabs obtained are broken by sieve to a size of <200 μm. The proportion of resulting fines remains in the product.

The average agglomerate size (d₅₀) of the boron nitride hybrid agglomerates produced in this manner is 56 μm.

The aluminum content, the aluminum-free content, the carbon content, the oxygen content, and the specific surface area are determined as described in example 1. After annealing, the total aluminum content in the boron nitride hybrid flakes is 24.2% by weight. This results in an aluminum nitride proportion, from the aluminum proportion, in the boron nitride agglomerate of 36.5% by weight. The aluminum-free content is 0.58% by weight, the carbon content is 0.12% by weight, and the oxygen content is 0.15% by weight. The specific surface (BET) is 6.5 m²/g.

Aluminum nitride can be verified radiographically in the boron nitride hybrid agglomerates obtained, in addition to hexagonal boron nitride as the main phase. The texture index determined is 1.7

From the boron nitride hybrid agglomerates produced <200 μm, the fine proportion <100 μm is separated off by sieving. The agglomerate stability is determined on the 100-200 μm sieve fraction of the boron nitride agglomerates thus obtained by using the ultrasound method.

The agglomerate stability determined on the boron agglomerates is 85%.

In a twin screw extruder (Leistritz ZSE18 max, Nuremburg, Germany), PA 6 (Schulamid® 6 NV 12, A. Schulman, Kerpen, Germany) is added via a gravimetric main feeding, and boron nitride hybrid agglomerates, as produced previously, are added via a gravimetric side feeding. Screw configuration 2 according to FIG. 2 is used, a screw speed of 300 RPM is set, and a throughput rate of 6 kg/h is run; 3.8 kg/h PA 6 is added in the main feeding, and 2.2 kg/h hybrid agglomerates are added in the side feeding. The compound obtained is channeled through two 3-mm nozzles, then passes through a cooling section in the water bath, and is shredded to form granules. The proportion of boron nitride hybrid agglomerates in the compound is 20% by volume.

Injection molding and the thermal conductivity measurements are performed as described in example 1. The compounding parameters, the results of the thermal conductivity measurements, and the anisotropy ratio are listed in table 1.

### Example 19

### Production of a Compound Consisting of PA 6 with 30% by Volume Boron Nitride Hybrid Agglomerates

Production of the boron nitride hybrid agglomerates and compounding is carried out according to example 18, during which 30% by volume boron nitride hybrid agglomerates are compounded in PA 6 in this case instead of 20% by volume boron nitride hybrid agglomerates.

Injection molding and the thermal conductivity measurements are performed as described in example 1. The compounding parameters, the results of the thermal conductivity measurements, and the anisotropy ratio are listed in table 1.

### Example 20

### Production of a Compound Consisting of PA 6 with 40% by Volume Boron Nitride Hybrid Agglomerates

Production of the boron nitride hybrid agglomerates and compounding is carried out according to example 18, during which 40% by volume boron nitride hybrid agglomerates are compounded in PA 6 in this case instead of 20% by volume boron nitride hybrid agglomerates.

Injection molding and the thermal conductivity measurements are performed as described in example 1. The compounding parameters, the results of the thermal conductivity measurements, and the anisotropy ratio are listed in table 1.

### Example 21

### Production of a Compound Consisting of PA 6 with 20% by Volume Boron Nitride Hybrid Agglomerates

Production of the boron nitride hybrid agglomerates and compounding is carried out according to example 18, during which compounding takes place with screw configuration 2 according to FIG. 2 at a speed of 900 RPM. The proportion of boron nitride hybrid agglomerates in the compound is 20% by volume.

Injection molding and the thermal conductivity measurements are performed as described in example 1. The compounding parameters, the results of the thermal conductivity measurements, and the anisotropy ratio are listed in Table 1.

### Example 22

### Production of a Compound Consisting of PA 6 with 30% by Volume Boron Nitride Hybrid Agglomerates

Production of the boron nitride hybrid agglomerates and compounding is carried out according to example 18, during which compounding takes place with screw configuration 2 according to FIG. 2 at a speed of 900 RPM and during which 30% by volume boron nitride hybrid agglomerates are compounded in PA 6 in this case instead of 20% by volume boron nitride hybrid agglomerates.

Injection molding and the thermal conductivity measurements are performed as described in example 1. The compounding parameters, the results of the thermal conductivity measurements, and the anisotropy ratio are listed in table 1.

### Example 23

### Production of a Compound Consisting of PA 6 with 20% by Volume Boron Nitride Hybrid Agglomerates

Production of the boron nitride hybrid agglomerates and compounding is carried out according to example 18, during which compounding takes place with screw configuration 1.

Injection molding and the thermal conductivity measurements are performed as described in example 1. The compounding parameters, the results of the thermal conductivity measurements, and the anisotropy ratio are listed in table 1.

### Example 24

### Production of a Compound Consisting of PA 6 with 30% by Volume Boron Nitride Hybrid Agglomerates

Production of the boron nitride hybrid agglomerates and compounding is carried out according to example 19, during which compounding takes place with screw configuration 1.

Injection molding and the thermal conductivity measurements are performed as described in example 1. The compounding parameters, the results of the thermal conductivity measurements, and the anisotropy ratio are listed in table 1.

### Example 25

### Production of a Compound Consisting of PA 6 with 40% by Volume Boron Nitride Hybrid Agglomerates

Production of the boron nitride hybrid agglomerates and compounding is carried out according to example 20, during which compounding takes place with screw configuration 1.

Injection molding and the thermal conductivity measurements are performed as described in example 1. The compounding parameters, the results of the thermal conductivity measurements, and the anisotropy ratio are listed in table 1.

### Example 26

### Production of a Compound Consisting of PA 6 with 20% by Volume Boron Nitride Hybrid Agglomerates

Production of the boron nitride hybrid agglomerates and compounding is carried out according to example 21, during which compounding takes place with screw configuration 1.

Injection molding and the thermal conductivity measurements are performed as described in example 1. The compounding parameters, the results of the thermal conductivity measurements, and the anisotropy ratio are listed in table 1.

### Example 27

### Production of a Compound Consisting of PA 6 with 30% by Volume Baron Nitride Hybrid Agglomerates

Production of the boron nitride hybrid agglomerates and compounding is carried out according to example 22, during which compounding takes place with screw configuration 1.

Injection molding and the thermal conductivity measurements are performed as described in example 1. The compounding parameters, the results of the thermal conductivity measurements, and the anisotropy ratio are listed in table 1.

### Example 28

### Production of a Compound Consisting of PA 6 with 40% by Volume Boron Nitride Hybrid Agglomerates

Production of the boron nitride hybrid agglomerates and compounding is carried out according to example 25, during which compounding takes place at a screw speed of 900 RPM.

Injection molding and the thermal conductivity measurements are performed as described in example 1. The compounding parameters, the results of the thermal conductivity measurements, and the anisotropy ratio are listed in table 1.

### Example 29

### Production of Boron Nitride Hybrid Flakes (Isotropic Scale-Like Nitride-Bonded Boron Nitride Agglomerates) and Production of a Compound Consisting of PA 6 with 20% by Volume Boron Nitride Hybrid Flakes

The production of the boron nitride hybrid flakes is performed according to example 1 during which 5.3 kg aluminum paste STAPA ALUPOR SK I-NE/70 (Eckart, Hartenstein, Germany) and 6 kg boron nitride powder BORONID® S1-SF (ESK Ceramics GmbH & Co. KG, Germany, average particle size (d₅₀)=3 μm, measured using laser diffraction (Mastersizer 2000, Malvern, wet measurement)) are used. This results in boron nitride hybrid flakes with a thickness of 10 μm, and up to several centimeters in diameter. After annealing which is performed as described in example 1, the total aluminum proportion in the boron nitride hybrid flakes is 33.3% by weight measured using alkaline melt fusion and ICP-OES (Arcos, Spectro, Kleve, Germany). This results in an aluminum nitride proportion, from the aluminum proportion, in the boron nitride hybrid flakes of 50% by weight.

With X-ray radiography, it was possible to detect only the phases boron nitride and aluminum nitride. The boron nitride hybrid flakes in the sieve fraction <500 μm have an average agglomerate diameter (d₅₀) of 78 μm measured by means of laser diffraction (Mastersizer 2000, Malvern, wet measurement). The thickness of the boron nitride hybrid flakes is 10 μm. The thickness is determined with a high-precision digital gauge.

The SEM overview image of the produced boron nitride hybrid flakes in sieve fraction <500 μm (FIG. 5) shows the flat surfaces of the agglomerates. These surfaces are shaped surfaces that were created directly by the shaping method (compacting between two counter-rotating rollers) and were not the result of subsequent crushing.

From the boron nitride hybrid flakes produced, a fraction <200 μm is fractured and the fines <100 μm are separated off by sieving. The agglomerate stability is determined on the 100-200 μm sieve fraction of the boron nitride hybrid flakes obtained in this manner using the ultrasound method. The agglomerate stability determined on the hybrid flakes is 80%.

Compounding is performed according to example 1 with screw configuration 1, during which 20% by volume boron nitride hybrid flakes is compounded in PA 6 in this case instead of 10% by volume boron nitride hybrid flakes. A screw speed of 300 RPM is set and a throughput rate of 6 kg/h is run; 3.8 kg/h PA 6 is added in the main feeding, and 2.2 kg/h boron nitride hybrid flakes from the <500 μm sieve fraction are added in the side feeding.

Injection molding and the thermal conductivity measurements are performed as described in example 1. The compounding parameters, the results of the thermal conductivity measurements, and the anisotropy ratio are listed in table 1.

### Example 30

### Production of a Compound Consisting of PA 6 with 30% by Volume Boron Nitride Hybrid Flakes

Production of the boron nitride hybrid flakes and compounding is carried out according to example 29, during which 30% by volume boron nitride hybrid agglomerates are compounded in PA 6 in this case instead of 20% by volume boron nitride hybrid agglomerates.

Injection molding and the thermal conductivity measurements are performed as described in example 1. The compounding parameters, the results of the thermal conductivity measurements, and the anisotropy ratio are listed in table 1.

### Example 31

### Production of a Compound Consisting of PA 6 with 40% by Volume Boron Nitride Hybrid Flakes

Production of the boron nitride hybrid flakes and compounding is carried out according to example 29, during which 40% by volume boron nitride hybrid agglomerates are compounded in PA 6 in this case instead of 20% by volume boron nitride hybrid agglomerates.

Injection molding and the thermal conductivity measurements are performed as described in example 1. The compounding parameters, the results of the thermal conductivity measurements, and the anisotropy ratio are listed in table 1.

### Example 32

### Production of a Compound Consisting of PA 6 with 20% by Volume Boron Nitride Hybrid Flakes

Production of the boron nitride hybrid flakes and compounding is carried out according to example 29, during which a screw speed of 900 RPM is set during compounding instead of 300 RPM.

Injection molding and the thermal conductivity measurements are performed as described in example 1. The compounding parameters, the results of the thermal conductivity measurements, and the anisotropy ratio are listed in table 1.

### Example 33

### Production of a Compound Consisting of PA 6 with 30% by Volume Boron Nitride Hybrid Flakes

Production of the boron nitride hybrid flakes and compounding is carried out according to example 30, during which a screw speed of 900 RPM is set during compounding instead of 300 RPM.

Injection molding and the thermal conductivity measurements are performed as described in example 1. The compounding parameters, the results of the thermal conductivity measurements, and the anisotropy ratio are listed in table 1.

### Example 34

### Production of a Compound Consisting of PA 6 with 20% by Volume Boron Nitride Hybrid Flakes

Production of the boron nitride hybrid flakes and compounding are carried out according to example 29, during which compounding takes place with screw configuration 2.

Injection molding and the thermal conductivity measurements are performed as described in example 1. The compounding parameters, the results of the thermal conductivity measurements, and the anisotropy ratio are listed in table 1.

### Example 35

### Production of a Compound Consisting of PA 6 with 30% by Volume Boron Nitride Hybrid Flakes

Production of the boron nitride hybrid flakes and compounding is carried out according to example 30, during which compounding takes place with screw configuration 2.

Injection molding and the thermal conductivity measurements are performed as described in example 1. The compounding parameters, the results of the thermal conductivity measurements, and the anisotropy ratio are listed in table 1.

### Example 36

### Production of a Compound Consisting of PA 6 with 20% by Volume Boron Nitride Hybrid Flakes

Production of the boron nitride hybrid flakes and compounding is carried out according to example 32, during which compounding takes place with screw configuration 2.

Injection molding and the thermal conductivity measurements are performed as described in example 1. The compounding parameters, the results of the thermal conductivity measurements, and the anisotropy ratio are listed in table 1.

### Example 37

### Production of a Compound Consisting of PA 6 with 30% by Volume Boron Nitride Hybrid Flakes

Production of the boron nitride hybrid flakes and compounding is carried out according to example 33, during which compounding takes place with screw configuration 2.

Injection molding and the thermal conductivity measurements are performed as described in example 1. The compounding parameters, the results of the thermal conductivity measurements, and the anisotropy ratio are listed in table 1.

### Reference Example 1

### Production of a Compound Consisting of PA 6 with 30% by Volume TCP015-100

In a twin screw extruder (Leistritz ZSE18 max, Nuremburg, Germany), the polyamide PA 6 (Schulamid®6 NV 12, A. Schulman, Kerpen, Germany) is added in a gravimetric main feeding as the polymer, and boron nitride agglomerates TCP015-100 (ESK Ceramics, Kempten, Germany) are added via a gravimetric side feeding. The rough screw configuration, configuration 1, is used. A screw speed of 900 RPM is set and a throughput of 6 kg/h is run; 3.3 kg/h PA 6 is added in the main feeding, and 2.7 kg/h boron nitride powder TCP015-100 having a primary boron nitride particle size of 15 μm is added in the side feeding. The compound obtained is channeled through two 3-mm nozzles, then passes through a cooling section in the water bath, and is then shredded to form granules. The proportion of boron nitride in the compound is 30% by volume. Injection molding and the thermal conductivity measurements are performed as described in example 1. The compounding parameters, the results of the thermal conductivity measurements, and the anisotropy ratio are listed in table 2.

The boron nitride agglomerates are dispersed in the injection-molded plates as primary particles, which can be verified in the SEM images of the transverse sections and fracture surfaces of the injection-molded plates.

### Reference Example 2

### Production of a Compound Consisting of PA 6 with 40% by Volume TCP015-100

Compounding is performed according to reference example 1, in which 40% by volume boron nitride agglomerates TCP015-100 is compounded in PA 6 in this case instead of 30% by volume TCP015-100.

Injection molding and the thermal conductivity measurements are performed as described in example 1. The compounding parameters, the results of the thermal conductivity measurements, and the anisotropy ratio are listed in table 2.

The boron nitride agglomerates are dispersed in the injection-molded plates as primary particles, which can be verified in the SEM images of the transverse sections and fracture surfaces of the injection-molded plates.

### Reference Example 3

### Production of a Compound Consisting of PA 6 with 50% by Volume TCP015-100

Compounding is performed according to reference example 1, in which 50% by volume boron nitride agglomerates TCP015-100 is compounded in PA 6 in this case instead of 30% by volume TCP015-100.

Injection molding and the thermal conductivity measurements are performed as described in example 1. The compounding parameters, the results of the thermal conductivity measurements, and the anisotropy ratio are listed in Table 2.

The boron nitride agglomerates are dispersed in the injection-molded plates as primary particles, which can be verified in the SEM images of the transverse sections and fracture surfaces of the injection-molded plates.

### Reference Example 4

### Production of a Compound Consisting of PA 6 with 10% by Volume Aluminosilicate

In a twin screw extruder (Leistritz ZSE18 max, Nuremburg, Germany), the polyamide PA 6 (Schulamid® 6 NV 12, A. Schulman, Kerpen, Germany) is added via a gravimetric main feeder as the polymer, and the aluminosilicate Trefil 1360-400 (Quarzwerke, Frechen, Germany) having an average particle size (d₅₀) of 6.3 μm is added via a gravimetric side feeder. The rough screw configuration, configuration 1, is used. A screw speed of 300 RPM is set and a throughput of 6 kg/h is run; 4.4 kg/h PA 6 is added during the main feeding and 1.6 kg/h aluminosilicate is added during the side feeding. The compound obtained is channeled through two 3-mm nozzles, then passes through a cooling line in the water bath, and is shredded to form granules. The proportion of aluminosilicate in the compound is 10% by volume.

Injection molding and the thermal conductivity measurements are performed as described in example 1. The compounding parameters, the results of the thermal conductivity measurements, and the anisotropy ratio are listed in table 2.

### Reference Example 5

Production of a compound consisting of PA 6 with 20% by volume aluminosilicate Compounding is performed according to reference example 4, in which 20% by volume aluminosilicate is compounded in PA 6 in this case instead of 10% by volume aluminosilicate.

Injection molding and the thermal conductivity measurements are performed as described in example 1. The compounding parameters, the results of the thermal conductivity measurements, and the anisotropy ratio are listed in table 2.

### Reference Example 6

### Production of a Compound Consisting of PA 6 with 30% by Volume Aluminosilicate

Compounding is performed according to reference example 4, in which 30% by volume aluminosilicate is compounded in PA 6 in this case instead of 10% by volume aluminosilicate.

Injection molding and the thermal conductivity measurements are performed as described in example 1. The compounding parameters, the results of the thermal conductivity measurements, and the anisotropy ratio are listed in table 2.

### Reference Example 7

### Production of a Compound Consisting of PA 6 with 40% by Volume Aluminosilicate

Compounding is performed according to reference example 4, in which 40% by volume aluminosilicate is compounded in PA 6 in this case instead of 10% by volume aluminosilicate.

Injection molding and the thermal conductivity measurements are performed as described in example 1. The compounding parameters, the results of the thermal conductivity measurements, and the anisotropy ratio are listed in table 2.

### Reference Example 8

### Production of a Compound Consisting of PA 6 with 50% by Volume Aluminosilicate

Compounding is performed according to reference example 4, in which 50% by volume aluminosilicate is compounded in PA 6 in this case instead of 10% by volume aluminosilicate.

Injection molding and the thermal conductivity measurements are performed as described in example 1. The compounding parameters, the results of the thermal conductivity measurements, and the anisotropy ratio are listed in Table 2.

### Reference Example 9

### Production of a Compound Consisting of PA 6 with 10% by Volume Magnesium Hydroxide

In a twin screw extruder (Leistritz ZSE18 max, Nuremburg, Germany), the polyamide PA 6 (Schulamid® 6 NV 12, A. Schulman, Kerpen, Germany) is added via a gravimetric main feeder as the polymer, and magnesium hydroxide (APYMAG 40, Nabaltech, Schwandorf, Germany) having an average particle size (d₅₀) of 5 μm is added via a gravimetric side feeder. The rough screw configuration, configuration 1, is used. A screw speed of 300 RPM and a throughput rate of 6 kg/h are set; 4.9 kg/h PA 6 is added during the main feeding and 1.1 kg/h magnesium hydroxide is added during the side feeding. The compound obtained is channeled through two 3-mm nozzles, then passes through a cooling section in the water bath, and is shredded to form granules. The proportion of magnesium hydroxide in the compound is 10% by volume.

Injection molding and the thermal conductivity measurements are performed as described in example 1. The compounding parameters, the results of the thermal conductivity measurements, and the anisotropy ratio are listed in Table 2.

### Reference Example 10

### Production of a Compound Consisting of PA 6 with 20% by Volume Magnesium Hydroxide

Compounding is performed according to reference example 9, in which 20% by volume magnesium hydroxide is compounded in PA 6 in this case instead of 10% by volume magnesium hydroxide.

Injection molding and the thermal conductivity measurements are performed as described in example 1. The compounding parameters, the results of the thermal conductivity measurements, and the anisotropy ratio are listed in table 2.

### Reference Example 11

### Production of a Compound Consisting of PA 6 with 30% by Volume Magnesium Hydroxide

Compounding is performed according to reference example 9, in which 30% by volume magnesium hydroxide is compounded in PA 6 in this ease instead of 10% by volume magnesium hydroxide.

Injection molding and the thermal conductivity measurements are performed as described in example 1. The compounding parameters, the results of the thermal conductivity measurements, and the anisotropy ratio are listed in table 2.

### Reference Example 12

### Production of a Compound Consisting of PA 6 with 40% by Volume Magnesium Hydroxide

Compounding is performed according to reference example 9, in which 40% by volume magnesium hydroxide is compounded in PA 6 in this case instead of 10% by volume magnesium hydroxide.

Injection molding and the thermal conductivity measurements are performed as described in example 1. The compounding parameters, the results of the thermal conductivity measurements, and the anisotropy ratio are listed in table 2.

TABLE 1

| | | | In-plane | Through- | | | |
|---|---|---|---|---|---|---|---|
| | Boron nitride | Secondary | thermal | plane thermal | | | Screw |
| Example | agglomerates | filler | conductivity | conductivity | Anisotropy | Screw | speed |
| No. | [Vol. %] | [Vol. %] | [W/m * K] | [W/m * K] | ratio | configuration | [RPM] |
| 1 | 10 | 0 | 0.89 | 0.48 | 1.8 | 1 | 300 |
| 2 | 20 | 0 | 1.86 | 0.75 | 2.5 | 1 | 300 |
| 3 | 30 | 0 | 2.90 | 1.22 | 2.4 | 1 | 300 |
| 4 | 40 | 0 | 4.55 | 1.90 | 2.4 | 1 | 300 |
| 5 | 50 | 0 | 6.01 | 2.60 | 2.3 | 1 | 300 |
| 6 | 10 | 10 | 1.25 | 0.65 | 1.9 | 1 | 300 |
| 7 | 10 | 20 | 1.39 | 0.84 | 1.7 | 1 | 300 |
| 8 | 10 | 30 | 1.83 | 1.26 | 1.5 | 1 | 300 |
| 9 | 10 | 40 | 3.19 | 1.51 | 2.1 | 1 | 300 |
| 10 | 20 | 10 | 2.41 | 1.10 | 2.2 | 1 | 300 |
| 11 | 20 | 20 | 3.24 | 1.53 | 2.1 | 1 | 300 |
| 12 | 20 | 30 | 3.61 | 1.97 | 1.8 | 1 | 300 |
| 13 | 30 | 10 | 3.78 | 1.76 | 2.1 | 1 | 300 |
| 14 | 30 | 20 | 4.83 | 2.23 | 2.2 | 1 | 300 |
| 15 | 40 | 10 | 5.77 | 2.52 | 2.3 | 1 | 300 |
| 16 | 20 | 20 | 2.56 | 1.17 | 2.2 | 1 | 300 |
| 17 | 30 | 10 | 3.45 | 1.44 | 2.4 | 1 | 300 |
| 18 | 20 | 0 | 1.18 | 0.75 | 1.6 | 2 | 300 |
| 19 | 30 | 0 | 2.22 | 1.36 | 1.6 | 2 | 300 |
| 20 | 40 | 0 | 3.52 | 1.70 | 2.1 | 2 | 300 |
| 21 | 20 | 0 | 1.15 | 0.66 | 1.7 | 2 | 900 |
| 22 | 30 | 0 | 2.18 | 1.21 | 1.8 | 2 | 900 |
| 23 | 20 | 0 | 1.26 | 0.82 | 1.5 | 1 | 300 |
| 24 | 30 | 0 | 2.30 | 1.38 | 1.7 | 1 | 300 |
| 25 | 40 | 0 | 3.43 | 1.83 | 1.9 | 1 | 300 |
| 26 | 20 | 0 | 1.35 | 0.80 | 1.7 | 1 | 900 |
| 27 | 30 | 0 | 2.10 | 1.22 | 1.7 | 1 | 900 |
| 28 | 40 | 0 | 3.66 | 1.72 | 2.1 | 1 | 900 |
| 29 | 20 | 0 | 1.52 | 1.00 | 1.5 | 1 | 300 |
| 30 | 30 | 0 | 2.87 | 1.65 | 1.7 | 1 | 300 |
| 31 | 40 | 0 | 4.07 | 2.04 | 2.0 | 1 | 300 |
| 32 | 20 | 0 | 1.39 | 0.90 | 1.6 | 1 | 900 |
| 33 | 30 | 0 | 2.47 | 1.47 | 1.7 | 1 | 900 |
| 34 | 20 | 0 | 1.42 | 0.90 | 1.6 | 2 | 300 |
| 35 | 30 | 0 | 2.57 | 1.61 | 1.6 | 2 | 300 |
| 36 | 20 | 0 | 1.61 | 0.95 | 1.7 | 2 | 900 |
| 37 | 30 | 0 | 2.45 | 1.45 | 1.7 | 2 | 900 |

TABLE 2

| | | | | Through- | | | |
|---|---|---|---|---|---|---|---|
| | | | In-plane | plane | | | |
| Reference | Primary boron | | thermal | thermal | | | Screw |
| example | nitride particles | Secondary | conductivity | conductivity | Anisotropy | Screw | speed |
| No. | [Vol. %] | filler [Vol. %] | [W/m * K] | [W/m * K] | ratio | configuration | [RPM] |
| 1 | 30 | 0 | 3.98 | 0.82 | 4.9 | 1 | 900 |
| 2 | 40 | 0 | 6.72 | 0.95 | 7.1 | 1 | 900 |
| 3 | 50 | 0 | 9.5 | 1.01 | 9.4 | 1 | 900 |
| 4 | 0 | 10 | 0.46 | 0.38 | 1.2 | 1 | 300 |
| 5 | 0 | 20 | 0.74 | 0.56 | 1.3 | 1 | 300 |
| 6 | 0 | 30 | 1.01 | 0.77 | 1.3 | 1 | 300 |
| 7 | 0 | 40 | 1.43 | 1.05 | 1.4 | 1 | 300 |
| 8 | 0 | 50 | 1.93 | 1.54 | 1.3 | 1 | 300 |
| 9 | 0 | 10 | 0.43 | 0.38 | 1.1 | 1 | 300 |
| 10 | 0 | 20 | 0.70 | 0.52 | 1.3 | 1 | 300 |
| 11 | 0 | 30 | 0.94 | 0.68 | 1.4 | 1 | 300 |
| 12 | 0 | 40 | 1.38 | 0.89 | 1.5 | 1 | 300 |

1. A component part having a wall thickness of at most 3 mm on at least one part of the component part, wherein the component part is produced by thermoplastic processing of a polymer/boron nitride compound, and wherein the polymer/boron nitride compound comprises a thermoplastically processable polymer material and a thermally conducting filler, and wherein the filler comprises boron nitride agglomerates.

2. The component part according to claim 1, wherein the through-plane thermal conductivity of the component part is at least 1 W/m*K, wherein the thermal conductivity is measured according to DIN EN ISO 22007-4 on disk-shaped, injection-molded samples having a thickness of 2 mm.

3. The component part according to claim 1, wherein the in-plane thermal conductivity of the component part is at least 1.5 W/m*K, wherein the thermal conductivity is measured according to DIN EN ISO 22007-4 on disk-shaped, injection-molded samples having a thickness of 2 mm.

4. The component part according to claim 2, wherein the anisotropy ratio of the in-plane thermal conductivity to the through-plane thermal conductivity is at least 1.5 and at most 4.

5. The component part according to claim 1, wherein the proportion of boron nitride agglomerates is at least 5% by volume based on the total volume of the polymer/boron nitride compound.

6. The component part according to claim 1, wherein the boron nitride agglomerates comprise platelet-shaped hexagonal boron nitride primary particles which are connected to one another by means of an inorganic binder phase comprising at least one nitride and/or oxynitride.

7. The component part according to claim 6, wherein the inorganic binder phase of the boron nitride agglomerates comprises aluminum nitride (AlN), aluminum oxynitride, titanium nitride (TiN), silicon nitride (Si₃N₄), or/and boron nitride (BN).

8. The component part according to claim 6, wherein the boron nitride agglomerates have a binder phase proportion of at least 1% by weight based on the total quantity of boron nitride agglomerates in each case, and/or wherein the aspect ratio of the boron nitride agglomerates is from 1.0 to 1.8.

9. The component part according to claim 1, wherein the boron nitride agglomerates comprise platelet-shaped hexagonal primary boron nitride particles which are agglomerated with one another to form flake-like boron nitride agglomerates.

10. The component part according to claim 9, wherein the texture index of the scale-like boron nitride agglomerates is greater than 2.0, and/or
wherein the thickness of the scale-like boron nitride agglomerates is ≦500 μm, and/or wherein the aspect ratio of the scale-like boron nitride agglomerates is greater than 1.

11. The component part according to claim 9, wherein the scale-like boron nitride agglomerates comprise an inorganic binder phase.

12. The component part according to claim 11, wherein the scale-like boron nitride agglomerates have a binder phase proportion of at least 1%, based on the total quantity of the scale-like boron nitride agglomerates in each case.

13. The component part according to claim 11, wherein the binder phase comprises aluminum nitride (AlN), aluminum oxynitride, titanium nitride (TiN), silicon nitride (Si₃N₄), or/and boron nitride (BN).

14. The component part according to claim 1, comprising at least one filler different from boron nitride that increases thermal conductivity.

15. The component part according to claim 14, wherein the filler different from boron nitride is a metal powder; or wherein the filler different from boron nitride is carbon in the form of graphite, expanded graphite, or carbon black; or wherein the filler different from boron nitride is an oxide, nitride, or carbide; or wherein the filler different from boron nitride is a mineral filler.

16. The component part according to claim 14, wherein the total proportion of boron nitride agglomerates and the thermally conducting fillers different from boron nitride is at least 20% by volume based on the total volume of the polymer/boron nitride compound in each case.

17. The component part according to claim 1, wherein the wall thickness of the component part is at most 2 mm on at least one part of the component part.

18. The polymer/boron nitride compound for producing a component part according to claim 1, wherein the polymer/boron nitride compound comprises a thermoplastically processable polymer material and a thermally conductive filler, wherein the filler comprises boron nitride agglomerates.

19. Use of a component part according to claim 1 for heat dissipation from component parts or assemblies to be cooled, preferably from electronic component parts or assemblies.
